(19) United States
(12) Patent Application Publication
(10) Pub. No.: US 2015/0011688 A1
(43) Pub. Date: Jan. 8, 2015

(54) Blended Thermoplastic Compositions With Improved Optical Properties and Flame Retardance

(71) Applicant: SABIC Global Technologies B.V., Bergen op Zoom (NL)

(72) Inventors: Narong An, Shanghai (CN); Hiromi Ishida, Moka-shi Tochigi-ken (JP); Hiroshi Iida, Moka-shi Tochigi-ken (JP); Pei Sun, Shanghai (CN); Dake Shen, Shanghai (CN)

(21) Appl. No.: 14/317,142

(22) Filed: Jun. 27, 2014

Related U.S. Application Data
(60) Provisional application No. 61/842,615, filed on Jul. 3, 2013.

(51) Int. Cl. C08K 5/5419; C08K 5/52; C08K 7/14; C08K 5/5399

(52) U.S. Cl. CPC C08K 5/5419; C08K 5/5399; C08K 5/52; C08K 7/14
USPC 524/116; 524/127

(57) ABSTRACT

The present disclosure relates to blended thermoplastic compositions comprising at least one polycarbonate component, at least one reinforcing filler, at least one phosphorus-containing flame retardant component. The resulting thermoplastic composition can be used in the manufacture of articles requiring materials with improved flame retardancy and optical properties such as light transmittance, while retaining required modulus and impact properties.

### CROSS REFERENCE TO RELATED PATENT APPLICATION

This application claims priority to U.S. Patent Application No. 61/842,615 filed Jul. 3, 2013, herein incorporated by reference in its entirety.

### BACKGROUND

The mobile equipment market increasingly requires materials with better mechanical properties, flame retardancy, aesthetics and improved cost that can be successfully utilized in ever smaller and lighter personal electronic devices, such as laptop personal computers, smart phones, tablets, music players and the like. Traditionally, magnesium-aluminum alloys have been employed in a production of the production of high-end portable personal computers or similar devices. However, casting of magnesium-aluminum alloys is both labor intensive and requires additional processing steps to improve functional and aesthetic aspects of the manufactured article.

To minimize cost and processing steps, thermoplastic resins have been adapted for use in the housings for small, lightweight personal electronics devices, such as laptop computers, tablets, smart phones, and the like. In recent years, the mobile equipment market has been dominated by glass filled nylon and glass filled polycarbonate composites. Although these composites possess good mechanical and flame retardancy properties, these components frequently lack the desired level of transparency and haze, which limits their use in applications which require high chroma colors for improved device aesthetics.

Accordingly, there remains a need for compositions that are flame retardant, have good mechanical and optical properties, and are cost effective. This and other needs are satisfied by the various aspects of the present disclosure.

### SUMMARY

In accordance with the purpose(s) of the disclosure, as embodied and broadly described herein, this disclosure, in one aspect, the present disclosure relates to blended thermoplastic compositions comprising at least one polycarbonate component, at least one reinforcing filler, at least one phosphorus-containing flame retardant component, and at least one flame retardant synergist component. The resulting thermoplastic composition can be used in the manufacture of articles requiring materials with improved flame retardancy and optical properties such as light transmittance, while retaining required modulus and impact properties. The present disclosure also relates to a method of manufacturing the blended thermoplastic compositions.

In one aspect, disclosed herein, a blended thermoplastic composition comprising a) from about 47 wt % to about 91.5 wt % of a polycarbonate polymer component; and b) from about 5 wt % to about 50 wt % of a reinforcing filler; and c) from about 3 wt % to about 7 wt % of a flame retardant; wherein the combined weight percent value of all components does not exceed about 100 wt %; and wherein all weight percent values are based on the total weight of the composition. In another aspect, the blended thermoplastic composition can further comprise d) a flame retardant synergist.

The disclosed blended thermoplastic composition has desirable optical properties, including a high percent of transmittance and a relatively low percent of haze, and they retain desirable mechanical performance properties, and high flame retardancy. The composition has improved appearance properties, as well as the ability to achieve high chroma colors to satisfy consumers' demands.

According to further aspects, disclosed are compositions that have improved flame retardancy that does not compromise the mechanical and optical properties of the composition.

In various further aspects, the disclosure relates to articles comprising the disclosed compositions.

In a further aspect, the disclosure relates to methods of making the disclosed compositions.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

The present disclosure can be understood more readily by reference to the following detailed description, examples, drawings, and claims, and their previous and following description. However, before the present compositions, articles, devices, systems, and/or methods are disclosed and described, it is to be understood that this disclosure is not limited to the specific compositions, articles, devices, systems, and/or methods disclosed unless otherwise specified, as such can, of course, vary. It is also to be understood that the terminology used herein is for the purpose of describing particular aspects only and is not intended to be limiting.

The following description of the disclosure is also provided as an enabling teaching of the disclosure in its best, currently known aspect. To this end, those of ordinary skill in the relevant art will recognize and appreciate that changes and modifications can be made to the various aspects of the disclosure described herein, while still obtaining the beneficial results of the present disclosure. It will also be apparent that some of the desired benefits of the present disclosure can be obtained by selecting some of the features of the present disclosure without utilizing other features. Accordingly, those of ordinary skill in the relevant art will recognize that many modifications and adaptations to the present disclosure are possible and can even be desirable in certain circumstances and are thus also a part of the present disclosure. Thus, the following description is provided as illustrative of the principles of the present disclosure and not in limitation thereof.

Various combinations of elements of this disclosure are encompassed by this disclosure, e.g. combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### DEFINITIONS

It is to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate” includes mixtures of two or more such polycarbonates. Furthermore, for example, reference to a filler includes mixtures of two or more such fillers.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” mean that the subsequently described event, condition, component, or circumstance may or may not occur, and that the description includes instances where said event or circumstance occurs and instances where it does not.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

Disclosed are component materials to be used to prepare disclosed compositions of the disclosure as well as the compositions themselves to be used within methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight, of a particular element or component in a composition or article denotes the weight relationship between the element or component and any other elements or components in the composition or article for which a part by weight is expressed. Thus, in a composition containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example if a particular element or component in a composition or article is said to have 8% weight, it is understood that this percentage is relation to a total compositional percentage of 100%.

Compounds disclosed herein are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “alkoxy” as used herein is an alkyl group bound through a single, terminal ether linkage; that is, an “alkoxy” group can be defined as —OR where R is alkyl as defined above. A “lower alkoxy” group is an alkoxy group containing from one to six carbon atoms.

The term “alkenyl group” as used herein is a hydrocarbon group of from 2 to 24 carbon atoms and structural formula containing at least one carbon-carbon double bond. Asymmetric structures such as (AB)C=C(CD) are intended to include both the E and Z isomers. This can be presumed in structural formulae herein wherein an asymmetric alkene is present, or it can be explicitly indicated by the bond symbol C.

The term “alkynyl group” as used herein is a hydrocarbon group of 2 to 24 carbon atoms and a structural formula containing at least one carbon-carbon triple bond.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “cycloalkyl group” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl group” is a cycloalkyl group as defined above where at least one of the carbon atoms of the ring is substituted with a heteroatom such as, but not limited to, nitrogen, oxygen, sulfur, or phosphorus.

The term “aralkyl” as used herein is an aryl group having an alkyl, alkynyl, or alkenyl group as defined above attached to the aromatic group. An example of an aralkyl group is a benzyl group.

The term “hydroxyalkyl group” as used herein is an alkyl, alkenyl, alkynyl, aryl, aralkyl, cycloalkyl, halogenated alkyl, or heterocycloalkyl group described above that has at least one hydrogen atom substituted with a hydroxyl group.

The term “alkoxyalkyl group” is defined as an alkyl, alkenyl, alkynyl, aryl, aralkyl, cycloalkyl, halogenated alkyl, or heterocycloalkyl group described above that has at least one hydrogen atom substituted with an alkoxy group described above.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “carbonate group” as used herein is represented by the formula —OC(O)OR, where R can be hydrogen, an alkyl, alkenyl, alkynyl, aryl, aralkyl, cycloalkyl, halogenated alkyl, or heterocycloalkyl group described above.

The term “carboxylic acid” as used herein is represented by the formula —C(O)OH.

The term “aldehyde” as used herein is represented by the formula —C(O)H.

The term “keto group” as used herein is represented by the formula —C(O)R, where R is an alkyl, alkenyl, alkynyl, aryl, aralkyl, cycloalkyl, halogenated alkyl, or heterocycloalkyl group described above.

The term “carbonyl group” as used herein is represented by the formula C═O.

The term “ether” as used herein is represented by the formula AOA¹, where A and A¹ can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “sulfo-oxo group” as used herein is represented by the formulas —S(O)₂R, —OS(O)₂R, or, —OS(O)₂OR, where R can be hydrogen, an alkyl, alkenyl, alkynyl, aryl, aralkyl, cycloalkyl, halogenated alkyl, or heterocycloalkyl group described above.

As used herein, the term “substantially identical reference composition” refers to a composition that is substantially identical to the inventive composition by consisting essentially of substantially the same proportions and components but in the absence of a single component.

As used herein, the terms “number average molecular weight” or “Mn” can be used interchangeably, and refer to the statistical average molecular weight of all the polymer chains in the sample and is defined by the formula:

$$Mn = \frac{\sum {N}_{i} {M}_{i}}{\sum {N}_{i}} ,$$

where Mᵢ is the molecular weight of a chain and Nᵢ is the number of chains of that molecular weight. Mn can be determined for polymers, such as polycarbonate polymers or polycarbonate-PMMA copolymers, by methods well known to a person having ordinary skill in the art. It is to be understood that as used herein, Mn is measured gel permeation chromatography and as calibrated with polycarbonate standards. For example, gel permeation chromatography can be carried out using a crosslinked styrene-divinyl benzene column, at a sample concentration of 1 milligram per milliliter with appropriate mobile phase solvents.

As used herein, the terms “weight average molecular weight” or “Mw” can be used interchangeably, and are defined by the formula:

$$Mw = \frac{\sum {N}_{i} {M}_{i}^{2}}{\sum {N}_{i} {M}_{i}} ,$$

where Mᵢ is the molecular weight of a chain and Nᵢ is the number of chains of that molecular weight. Compared to Mn, Mw takes into account the molecular weight of a given chain in determining contributions to the molecular weight average. Thus, the greater the molecular weight of a given chain, the more the chain contributes to the Mw. It is to be understood that as used herein, Mw is measured gel permeation chromatography. In some cases, Mw is measured gel permeation chromatography and calibrated with polycarbonate standards. Gel permeation chromatography can be carried out using a crosslinked styrene-divinyl benzene column, at a sample concentration of about 1 milligram per milliliter with appropriate mobile phase solvents.

As used herein, the terms “polydispersity index” or “PDI” can be used interchangeably, and are defined by the formula:

$$P D I = \frac{Mw}{Mn} .$$

The PDI has a value equal to or greater than 1, but as the polymer chains approach uniform chain length, the PDI approaches unity.

As used herein, the terms “mean” or “statistical mean”, can be used interchangeably, and are defined by the formula:

$$x = \frac{1}{n} {\sum }_{i = 1}^{n} {x}_{i}$$

wherein xᵢ is the measured value, and n is the number of values.

As used herein, the term “variance” refers to a numerical value that is used to indicate how widely the measured values in a group vary, and is defined by the formula:

$${σ}^{2} = \frac{\sum {( {x}_{i} - \overline{x} )}^{2}}{n}$$

wherein σ² is a variance, xᵢ is the measured value, x̅ is the mean value, and n is the number of values.

The terms “BisA” or “bisphenol A,” which can be used interchangeably, as used herein refers to a compound having a structure represented by the formula:

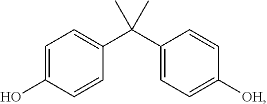 [SMILES: CC(C)(c1ccc(O)cc1)c1ccc(O)cc1]

BisA can also be referred to by the name 4,4′-(propane-2,2-diyl)diphenol; p,p′-isopropylidenebisphenol; or 2,2-bis(4-hydroxyphenyl)propane. BisA has the CAS #80-05-7.

As used herein, “polycarbonate” refers to an oligomer or polymer comprising residues of one or more dihydroxy compounds, e.g. dihydroxy aromatic compounds, joined by carbonate linkages; it also encompasses homopolycarbonates, copolycarbonates, and (co)polyester carbonates.

As used herein, the term “transparent” includes aspects wherein the level of transmittance for a disclosed composition is greater than 50%, including exemplary transmittance values of at least 60%, 70%, 80%, 85%, 90%, and 95%, or any range of transmittance values derived from the above exemplified values.

As used herein, the terms “transmittance” or “percent of transmittance” refer to the fraction of incident light at a specified wavelength that passes through a sample. Transmittance can be measured for a disclosed polymer in accordance with ASTM D1003.

As used herein, the term “haze” refers to the visual appearance of the compositions that is a result of the scattering of light out of the regular direction during reflection or transmission, and it includes aspects where the level of haze for a disclosed composition is less than 80%, including haze values of less than 70%, 60%, 50%, 40%, 30%, 20%, 10%, 5%, and 1%, or any range derived from these values. Haze can be measured for a disclosed polymer in accordance with ASTM D1003.

The terms “refractive index” or “index of refraction” as used herein refer to a dimensionless number that is a measure of the speed of light in that substance or medium. It is typically expressed as a ratio of the speed of light in vacuum relative to that in the considered substance or medium. This can be written mathematically as:

n=speed of light in a vacuum/speed of light in medium.

The terms “residues” and “structural units”, used in reference to the constituents of the polymers, are synonymous throughout the specification.

Each of the component materials disclosed herein are either commercially available and/or the methods for the production thereof are known to those of ordinary skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Blended Thermoplastic Compositions

As briefly described above, the present disclosure relates to blended thermoplastic compositions comprising at least one polycarbonate component, at least one reinforcing filler, at least one phosphorus-containing flame retardant component, and at least one flame retardant synergist component. The resulting thermoplastic composition can be used in the manufacture of articles requiring materials with improved flame retardancy and optical properties such as light transmittance, while retaining required modulus and impact properties. The present disclosure also relates to a method of manufacturing the blended thermoplastic compositions.

The present disclosure pertains to blend thermoplastic compositions comprising: a) from about 50 wt % to about 95 wt % of a polycarbonate polymer component; and b) from about 5 wt % to about 50 wt % of a reinforcing filler; and c) from about 3 wt % to about 7 wt % of a flame retardant; wherein the combined weight percent value of all components does not exceed about 100 wt %; and wherein all weight percent values are based on the total weight of the composition.

According to aspects of the disclosure, the disclosed blended thermoplastic composition is preferably transparent. To that end, the disclosed composition can exhibit a level of transmittance that is greater than 50%, including exemplary transmittance values of at least 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89, 90%, 91%, 92%, 93%, 94%, 95%, 96%, 97%, 98%, and 99%, or any range of transmittance values derived from the above exemplified values. In still further aspects, the disclosed composition exhibits relatively high levels of transparency characterized by exhibiting a transmittance of at least 80%. In a still further aspect, the disclosed composition exhibits a transmittance of at least 83%. Transparency can be measured for a disclosed polymer according to ASTM method D1003 at a thickness of 2 mm.

According to aspects of the disclosure, the disclosed composition preferably exhibits a level of “haze” that is less than 80%, including haze values of less than 70%, 60%, 50%, 40%, 30%, 20%, 10%, 5%, and 1%, or any range derived from these values. In still further aspects, the disclosed composition exhibits relatively low levels of haze characterized by exhibiting a “haze” value that is less than or equal to 30%. Haze can be measured for a disclosed polymer according to ASTM method D1003 at a thickness of 2 mm.

In various further aspects, the disclosed blended thermoplastic compositions can optionally further comprise at least one additive. In a further aspect, the disclosed blended thermoplastic compositions can optionally further comprise at least one additive selected from an anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof.

In one aspect, the flame retardancy of a blended thermoplastic composition can be determined using standardized test criteria, such as, for example, UL 94 tests. Thin articles present a particular challenge in the UL 94 tests, because compositions suitable for the manufacture of thin articles tend to have a higher flow. The blended thermoplastic compositions suitable for the manufacture of a variety of articles will generally have a melt volume rate (MVR) of about 4 to about 30 cm³/10 minutes measured at 300° C. under a load of 1.2 kg in accordance with ASTM D1238. Within this range, for thin wall applications, the MVR can be adjusted to greater than about 8, greater than about 10, or greater than about 13 cm³/10 minutes, measured at 300° C. under a load of 1.2 kg in accordance with ASTM D1238.

### Polycarbonate Polymer Component

In one aspect, disclosed herein are blended thermoplastic compositions comprising a polycarbonate polymer component, wherein the polycarbonate polymer component comprises a linear polycarbonate, a branched polycarbonate, or a combinations thereof. In a further aspect, the polycarbonate polymer component comprises a linear polycarbonate. In yet another aspect, the polycarbonate polymer component comprises a bisphenol A polycarbonate polymer. In a further aspect, the polycarbonate polymer component comprises a polycarbonate-polysiloxane copolymer. In a yet further aspect, the polycarbonate polymer component comprises a linear polycarbonate, a polycarbonate-polysiloxane copolymer, or a combinations thereof.

In one aspect, a polycarbonate can comprise any polycarbonate material or mixture of materials, for example, as recited in U.S. Pat. No. 7,786,246, which is hereby incorporated in its entirety for the specific purpose of disclosing various polycarbonate compositions and methods. The term polycarbonate can be further defined as compositions have repeating structural units of the formula (1):

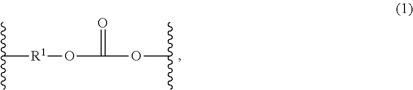

in which at least 60 percent of the total number of R¹ groups are aromatic organic radicals and the balance thereof are aliphatic, alicyclic, or aromatic radicals. In a further aspect, each R¹ is an aromatic organic radical and, more preferably, a radical of the formula (2):

-A¹-Y¹-A²- (2),

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene.

In a further aspect, polycarbonates can be produced by the interfacial reaction of dihydroxy compounds having the formula HO—R¹—OH, which includes dihydroxy compounds of formula (3):

HO-A¹-Y¹-A²-OH (3),

wherein Y¹, A¹ and A² are as described above. Also included are bisphenol compounds of general formula (4):

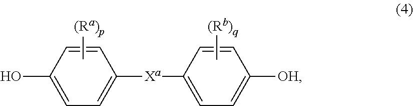

wherein R^{a} and R^{b} each represent a halogen atom or a monovalent hydrocarbon group and can be the same or different; p and q are each independently integers from 0 to 4; and X^{a} represents one of the groups of formula (5):

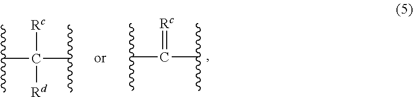

wherein R^{c} and R^{d} each independently represent a hydrogen atom or a monovalent linear or cyclic hydrocarbon group and R^{e} is a divalent hydrocarbon group.

In various aspects, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)—, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group can have 3 to 20 atoms, and can be a single saturated or unsaturated ring, or fused polycyclic ring system wherein the fused rings are saturated, unsaturated, or aromatic.

In various aspects, examples of suitable dihydroxy compounds include the dihydroxy-substituted hydrocarbons disclosed by name or formula (generic or specific) in U.S. Pat. No. 4,217,438. A nonexclusive list of specific examples of suitable dihydroxy compounds includes the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, 2,7-dihydroxycarbazole, 3,3-bis(4-hydroxyphenyl)phthalimidine, 2-phenyl-3,3-bis-(4-hydroxyphenyl)phthalimidine (PPPBP), and the like, as well as mixtures including at least one of the foregoing dihydroxy compounds.

In a further aspect, examples of the types of bisphenol compounds that can be represented by formula (3) includes 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl) n-butane, 2,2-bis(4-hydroxy-1-methylphenyl)propane, and 1,1-bis(4-hydroxy-t-butylphenyl)propane. Combinations including at least one of the foregoing dihydroxy compounds can also be used. In various further aspects, bisphenols containing substituted or unsubstituted cyclohexane units can be used, for example bisphenols of formula (6):

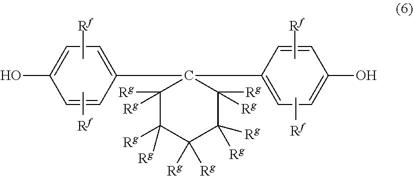

wherein each R^{f} is independently hydrogen, C₁₋₁₂ alkyl, or halogen; and each R^{g} is independently hydrogen or C₁₋₁₂ alkyl. The substituents can be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol containing polycarbonates, or a combination comprising at least one of the foregoing with other bisphenol polycarbonates, are supplied by Bayer Co. under the APEC® trade name.

In further aspects, additional useful dihydroxy compounds are those compounds having the formula HO—R¹—OH include aromatic dihydroxy compounds of formula (7):

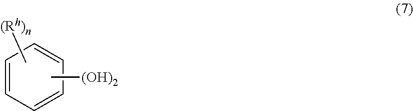

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

In addition to the polycarbonates described above, combinations of the polycarbonate with other thermoplastic polymers, for example combinations of homopolycarbonates and/or polycarbonate copolymers, can be used.

In various aspects, a polycarbonate can employ two or more different dihydroxy compounds or a copolymer of a dihydroxy compounds with a glycol or with a hydroxy- or acid-terminated polyester or with a dibasic acid or hydroxy acid in the event a carbonate copolymer rather than a homopolymer is desired for use. Polyarylates and polyester-carbonate resins or their blends can also be employed. Branched polycarbonates are also useful, as well as blends of linear polycarbonate and a branched polycarbonate. The branched polycarbonates can be prepared by adding a branching agent during polymerization.

In a further aspect, the branching agents include polyfunctional organic compounds containing at least three functional groups selected from hydroxyl, carboxyl, carboxylic anhydride, haloformyl, and mixtures thereof. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents can be added at a level of from 0.05-2.0 weight percent. Branching agents and procedures for making branched polycarbonates are described in U.S. Pat. Nos. 3,635,895 and 4,001,184. All types of polycarbonate end groups are contemplated as being useful in the thermoplastic composition.

In a further aspect, the polycarbonate can be a linear homopolymer derived from bisphenol A, in which each of A¹ and A² is p-phenylene and Y¹ is isopropylidene. In various further aspects, “polycarbonates” and “polycarbonate resins” as used herein further include homopolycarbonates, copolymers comprising different R¹ moieties in the carbonate (referred to herein as “copolycarbonates”), copolymers comprising carbonate units and other types of polymer units, such as ester units, polysiloxane units, and combinations comprising at least one of homopolycarbonates and copolycarbonates. As used herein, “combination” is inclusive of blends, mixtures, alloys, reaction products, and the like.

In one aspect, polycarbonates can be manufactured by processes such as interfacial polymerization and melt polymerization.

The polycarbonate compounds and polymers disclosed herein can, in various aspects, be prepared by a melt polymerization process. Generally, in the melt polymerization process, polycarbonates are prepared by co-reacting, in a molten state, the dihydroxy reactant(s) (i.e., isosorbide, aliphatic diol and/or aliphatic diacid, and any additional dihydroxy compound) and a diaryl carbonate ester, such as diphenyl carbonate, or more specifically in an aspect, an activated carbonate such as bis(methyl salicyl)carbonate, in the presence of a transesterification catalyst. The reaction can be carried out in typical polymerization equipment, such as one or more continuously stirred reactors (CSTRs), plug flow reactors, wire wetting fall polymerizers, free fall polymerizers, wiped film polymerizers, BANBURY® mixers, single or twin screw extruders, or combinations of the foregoing. In one aspect, volatile monohydric phenol can be removed from the molten reactants by distillation and the polymer is isolated as a molten residue.

In one aspect, volatile monohydric phenol can be removed from the molten reactants by distillation and the polymer is isolated as a molten residue. In another aspect, a useful melt process for making polycarbonates utilizes a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl)carbonate, bis(2-acetylphenyl)carboxylate, bis(4-acetylphenyl)carboxylate, or a combination comprising at least one of the foregoing.

The melt polymerization can include a transesterification catalyst comprising a first catalyst, also referred to herein as an alpha catalyst, comprising a metal cation and an anion. In an aspect, the cation is an alkali or alkaline earth metal comprising Li, Na, K, Cs, Rb, Mg, Ca, Ba, Sr, or a combination comprising at least one of the foregoing. The anion is hydroxide (OFF), superoxide (O²⁻), thiolate (HS⁻), sulfide (S²⁻), a C₁₋₂₀ alkoxide, a C₆₋₂₀ aryloxide, a C₁₋₂₀ carboxylate, a phosphate including biphosphate, a C₁₋₂₀ phosphonate, a sulfate including bisulfate, sulfites including bisulfites and metabisulfites, a C₁₋₂₀ sulfonate, a carbonate including bicarbonate, or a combination comprising at least one of the foregoing. In another aspect, salts of an organic acid comprising both alkaline earth metal ions and alkali metal ions can also be used. Salts of organic acids useful as catalysts are illustrated by alkali metal and alkaline earth metal salts of formic acid, acetic acid, stearic acid and ethyelenediaminetetraacetic acid. The catalyst can also comprise the salt of a non-volatile inorganic acid. By “nonvolatile”, it is meant that the referenced compounds have no appreciable vapor pressure at ambient temperature and pressure. In particular, these compounds are not volatile at temperatures at which melt polymerizations of polycarbonate are typically conducted. The salts of nonvolatile acids are alkali metal salts of phosphites; alkaline earth metal salts of phosphites; alkali metal salts of phosphates; and alkaline earth metal salts of phosphates. Exemplary transesterification catalysts include, lithium hydroxide, sodium hydroxide, potassium hydroxide, cesium hydroxide, magnesium hydroxide, calcium hydroxide, barium hydroxide, lithium formate, sodium formate, potassium formate, cesium formate, lithium acetate, sodium acetate, potassium acetate, lithium carbonate, sodium carbonate, potassium carbonate, lithium methoxide, sodium methoxide, potassium methoxide, lithium ethoxide, sodium ethoxide, potassium ethoxide, lithium phenoxide, sodium phenoxide, potassium phenoxide, sodium sulfate, potassium sulfate, NaH₂PO₃, NaH₂PO₄, Na₂H₂PO₃, KH₂PO₄, CsH₂PO₄, Cs₂H₂PO₄, Na₂SO₃, Na₂S₂O₅, sodium mesylate, potassium mesylate, sodium tosylate, potassium tosylate, magnesium disodium ethylenediamine tetraacetate (EDTA magnesium disodium salt), or a combination comprising at least one of the foregoing. It will be understood that the foregoing list is exemplary and should not be considered as limited thereto. In one aspect, the transesterification catalyst is an alpha catalyst comprising an alkali or alkaline earth salt. In an exemplary aspect, the transesterification catalyst comprising sodium hydroxide, potassium hydroxide, sodium carbonate, potassium carbonate, sodium methoxide, potassium methoxide, NaH₂PO₄, or a combination comprising at least one of the foregoing.

The amount of alpha catalyst can vary widely according to the conditions of the melt polymerization, and can be about 0.001 to about 500 μmol. In an aspect, the amount of alpha catalyst can be about 0.01 to about 20 μmol, specifically about 0.1 to about 10 μmol, more specifically about 0.5 to about 9 μmol, and still more specifically about 1 to about 7 μmol, per mole of aliphatic diol and any other dihydroxy compound present in the melt polymerization.

In another aspect, a second transesterification catalyst, also referred to herein as a beta catalyst, can optionally be included in the melt polymerization process, provided that the inclusion of such a second transesterification catalyst does not significantly adversely affect the desirable properties of the polycarbonate. Exemplary transesterification catalysts can further include a combination of a phase transfer catalyst of formula (R³)₄Q⁺X above, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalyst salts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing. Other melt transesterification catalysts include alkaline earth metal salts or alkali metal salts. In various aspects, where a beta catalyst is desired, the beta catalyst can be present in a molar ratio, relative to the alpha catalyst, of less than or equal to 10, specifically less than or equal to 5, more specifically less than or equal to 1, and still more specifically less than or equal to 0.5. In other aspects, the melt polymerization reaction disclosed herein uses only an alpha catalyst as described hereinabove, and is substantially free of any beta catalyst. As defined herein, “substantially free of” can mean where the beta catalyst has been excluded from the melt polymerization reaction. In one aspect, the beta catalyst is present in an amount of less than about 10 ppm, specifically less than 1 ppm, more specifically less than about 0.1 ppm, more specifically less than or equal to about 0.01 ppm, and more specifically less than or equal to about 0.001 ppm, based on the total weight of all components used in the melt polymerization reaction.

In one aspect, a melt process employing an activated carbonate is utilized. As used herein, the term “activated carbonate”, is defined as a diarylcarbonate that is more reactive than diphenylcarbonate in transesterification reactions. Specific non-limiting examples of activated carbonates include bis(o-methoxycarbonylphenyl)carbonate, bis(o-chlorophenyl)carbonate, bis(o-nitrophenyl)carbonate, bis(o-acetylphenyl)carbonate, bis(o-phenylketonephenyl)carbonate, bis(o-formylphenyl)carbonate. Examples of specific ester-substituted diarylcarbonates include, but are not limited to, bis(methylsalicyl)carbonate (CAS Registry No. 82091-12-1) (also known as BMSC or bis(o-methoxycarbonylphenyl) carbonate), bis(ethylsalicyl)carbonate, bis(propylsalicyl)carbonate, bis(butylsalicyl)carbonate, bis(benzylsalicyl)carbonate, bis(methyl-4-chlorosalicyl)carbonate and the like. In one aspect, bis(methylsalicyl)carbonate is used as the activated carbonate in melt polycarbonate synthesis due to its lower molecular weight and higher vapor pressure. Some non-limiting examples of non-activating groups which, when present in an ortho position, would not be expected to result in activated carbonates are alkyl, cycloalkyl or cyano groups. Some specific and non-limiting examples of non-activated carbonates are bis(o-methylphenyl)carbonate, bis(p-cumylphenyl)carbonate, bis(p-(1,1,3,3-tetramethyl)butylphenyl)carbonate and bis(o-cyanophenyl)carbonate. Unsymmetrical combinations of these structures can also be used as non-activated carbonates.

In one aspect, an end-capping agent (also referred to as a chain-stopper) can optionally be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned. Certain monophenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

In another aspect, endgroups can be derived from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In one aspect, the endgroup of a polycarbonate, including a polycarbonate polymer as defined herein, can comprise a structural unit derived from a diaryl carbonate, where the structural unit can be an endgroup. In a further aspect, the endgroup is derived from an activated carbonate. Such endgroups can be derived from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups.

In another aspect, the ester endgroup derived from a salicylic ester can be a residue of BMSC or other substituted or unsubstituted bis(alkyl salicyl)carbonate such as bis(ethyl salicyl)carbonate, bis(propyl salicyl)carbonate, bis(phenyl salicyl)carbonate, bis(benzyl salicyl)carbonate, or the like. In one aspect, where a combination of alpha and beta catalysts are used in the melt polymerization, a polycarbonate polymer prepared from an activated carbonate can comprise endgroups in an amount of less than 2,000 ppm, less than 1,500 ppm, or less than 1,000 ppm, based on the weight of the polycarbonate. In another aspect, where only an alpha catalyst is used in the melt polymerization, a polycarbonate polymer prepared from an activated carbonate can comprise endgroups in an amount of less than or equal to 500 ppm, less than or equal to 400 ppm, less than or equal to 300 ppm, or less than or equal to 200 ppm, based on the weight of the polycarbonate.

In one aspect, the reactants for the polymerization reaction using an activated aromatic carbonate can be charged into a reactor either in the solid form or in the molten form. Initial charging of reactants into a reactor and subsequent mixing of these materials under reactive conditions for polymerization can be conducted in an inert gas atmosphere such as a nitrogen atmosphere. The charging of one or more reactants can also be done at a later stage of the polymerization reaction. Mixing of the reaction mixture is accomplished by any methods known in the art, such as by stirring. Reactive conditions include time, temperature, pressure and other factors that affect polymerization of the reactants. Typically the activated aromatic carbonate is added at a mole ratio of 0.8 to 1.3, and more preferably 0.9 to 1.3, and all subranges there between, relative to the total moles of monomer unit compounds (i.e., aromatic dihydroxy compound, and aliphatic diacid or diol). In a specific aspect, the molar ratio of activated aromatic carbonate to monomer unit compounds is 1.013 to 1.29, specifically 1.015 to 1.028. In another specific aspect, the activated aromatic carbonate is BMSC.

In one aspect, the melt polymerization reaction can be conducted by subjecting the reaction mixture to a series of temperature-pressure-time protocols. In some aspects, this involves gradually raising the reaction temperature in stages while gradually lowering the pressure in stages. In one aspect, the pressure is reduced from about atmospheric pressure at the start of the reaction to about 1 millibar (100 Pa) or lower, or in another aspect to 0.1 millibar (10 Pa) or lower in several steps as the reaction approaches completion. The temperature can be varied in a stepwise fashion beginning at a temperature of about the melting temperature of the reaction mixture and subsequently increased to final temperature. In one aspect, the reaction mixture is heated from room temperature to about 150° C. In such an aspect, the polymerization reaction starts at a temperature of about 150° C. to about 220° C. In another aspect, the polymerization temperature can be up to about 220° C. In other aspects, the polymerization reaction can then be increased to about 250° C. and then optionally further increased to a temperature of about 320° C., and all subranges there between. In one aspect, the total reaction time can be from about 30 minutes to about 200 minutes and all subranges there between. This procedure will generally ensure that the reactants react to give polycarbonates with the desired molecular weight, glass transition temperature and physical properties. The reaction proceeds to build the polycarbonate chain with production of ester-substituted alcohol by-product such as methyl salicylate. In one aspect, efficient removal of the by-product can be achieved by different techniques such as reducing the pressure. Generally the pressure starts relatively high in the beginning of the reaction and is lowered progressively throughout the reaction and temperature is raised throughout the reaction.

In one aspect, the progress of the reaction can be monitored by measuring the melt viscosity or the weight average molecular weight of the reaction mixture using techniques known in the art such as gel permeation chromatography. These properties can be measured by taking discrete samples or can be measured on-line. After the desired melt viscosity and/or molecular weight is reached, the final polycarbonate product can be isolated from the reactor in a solid or molten form. It will be appreciated by a person skilled in the art, that the method of making aliphatic homopolycarbonate and aliphatic-aromatic copolycarbonates as described in the preceding sections can be made in a batch or a continuous process and the process disclosed herein is preferably carried out in a solvent free mode. Reactors chosen should ideally be self-cleaning and should minimize any “hot spots.” However, vented extruders similar to those that are commercially available can be used.

Polycarbonates can be also be manufactured by interfacial polymerization. Although the reaction conditions for interfacial polymerization can vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary aspect, an interfacial polymerization reaction to form carbonate linkages uses phosgene as a carbonate precursor, and is referred to as a phosgenation reaction.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 wt % based on the weight of bisphenol in the phosgenation mixture. In another aspect, an effective amount of phase transfer catalyst can be about 0.5 to about 2 wt % based on the weight of bisphenol in the phosgenation mixture.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

All types of polycarbonate end groups are contemplated as being useful in the polycarbonate composition, provided that such end groups do not significantly adversely affect desired properties of the compositions.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, monocarboxylic acid chlorides, and/or monochloroformates. Mono-phenolic chain stoppers are exemplified by monocyclic phenols such as phenol and C₁-C₂₂ alkyl-substituted phenols such as p-cumyl-phenol, resorcinol monobenzoate, and p- and tertiary-butyl phenol; and monoethers of diphenols, such as p-methoxyphenol. Alkyl-substituted phenols with branched chain alkyl substituents having 8 to 9 carbon atom can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

In various aspects, the linear polycarbonate polymer has a refractive index of greater than 1.55. In a further aspect, the linear polycarbonate polymer has a refractive index of greater than 1.56. In a still further aspect, the linear polycarbonate polymer has a refractive index of greater than 1.57. In a yet further aspect, the linear polycarbonate polymer has a refractive index of greater than 1.57. In an even further aspect, the linear polycarbonate polymer has a refractive index of greater than 1.59.

In a further aspect, the linear polycarbonate polymer has a refractive index of greater than about 1.570. In a still further aspect, the linear polycarbonate polymer has a refractive index of greater than about 1.571. In a yet further aspect, the linear polycarbonate polymer has a refractive index of greater than about 1.572. In an even further aspect, the linear polycarbonate polymer has a refractive index of greater than about 1.573. In a still further aspect, the linear polycarbonate polymer has a refractive index of greater than about 1.574. In a yet further aspect, the linear polycarbonate polymer has a refractive index of greater than about 1.575. In an even further aspect, the linear polycarbonate polymer has a refractive index of greater than about 1.576. In a still further aspect, the linear polycarbonate polymer has a refractive index of greater than about 1.577. In a yet further aspect, the linear polycarbonate polymer has a refractive index of greater than about 1.578. In an even further aspect, the linear polycarbonate polymer has a refractive index of greater than about 1.579.

In a further aspect, the linear polycarbonate polymer has a refractive index of about 1.570. In a still further aspect, the linear polycarbonate polymer has a refractive index of about 1.571. In a yet further aspect, the linear polycarbonate polymer has a refractive index of about 1.572. In an even further aspect, the linear polycarbonate polymer has a refractive index of about 1.573. In a still further aspect, the linear polycarbonate polymer has a refractive index of about 1.574. In a yet further aspect, the linear polycarbonate polymer has a refractive index of about 1.575. In an even further aspect, the linear polycarbonate polymer has a refractive index of about 1.576. In a still further aspect, the linear polycarbonate polymer has a refractive index of about 1.577. In a yet further aspect, the linear polycarbonate polymer has a refractive index of about 1.578. In an even further aspect, the linear polycarbonate polymer has a refractive index of about 1.579.

In still further aspects, the polycarbonate component of the disclosed blended thermoplastic composition can comprise a polycarbonate-polysiloxane copolymer component. As used herein, the term polycarbonate-polysiloxane copolymer is equivalent to polysiloxane-polycarbonate copolymer, polycarbonate-polysiloxane polymer, or polysiloxane-polycarbonate polymer. The polycarbonate polysiloxane copolymer has a polysiloxane structural unit and a polycarbonate structural unit. The polycarbonate structural unit of the polycarbonate polysiloxane copolymer can be derived from carbonate units of formula (1) as described above. The carbonate units can be derived from one or more dihydroxy monomers of formula (3) including bisphenol compound of formula (4), both as described and incorporated herein from above. The dihydroxy compound can be bisphenol-A.

In one aspect, R is the same or different, and is a C₁₋₁₃ monovalent organic group. For example, R can be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ aralkyl group, C₇-C₁₃ aralkoxy group, C₇-C₁₃ alkylaryl group, or C₇-C₁₃ alkylaryloxy group. The foregoing groups can be fully or partially halogenated with fluorine, chlorine, bromine, or iodine, or a combination thereof. In an aspect, where a transparent polymer is desired, R does not contain any halogen. Combinations of the foregoing R groups can be used in the same polymer.

The polysiloxane structural unit can be derived from a siloxane-containing dihydroxy compounds (also referred to herein as “hydroxyaryl end-capped polysiloxanes”) that contain diorganosiloxane unit blocks of formula (A):

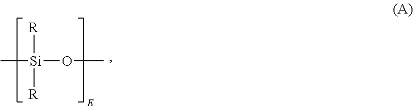

wherein each occurrence of R is same or different, and is a C₁₋₁₃ monovalent organic group. For example, R can be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ aralkyl group, C₇-C₁₃ aralkoxy group, C₇-C₁₃ alkylaryl group, or C₇-C₁₃ alkylaryloxy group. The foregoing groups can be fully or partially halogenated with fluorine, chlorine, bromine, or iodine, or a combination thereof. In an aspect, where a transparent polycarbonate is desired, R does not contain any halogen. Combinations of the foregoing R groups can be used in the same polycarbonate.

The value of E in formula (A) can vary widely depending on the type and relative amount of each of the different units in the polycarbonate, the desired properties of the polycarbonate, and like considerations. Generally, E can have an average value of about 2 to about 1,000, specifically about 2 to about 500, more specifically about 2 to about 100. In an aspect, E has an average value of about 4 to about 90, specifically about 5 to about 80, and more specifically about 40 to about 60.

In one aspect, the polysiloxane blocks are provided by repeating structural units of formula (B):

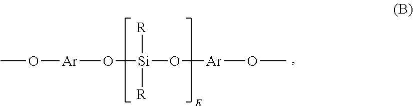

wherein E is as defined above; each R is the same or different, and is as defined above; and each Ar is the same or different, and Ar is one or more C₆-C₃₀ aromatic group(s), or one or more alkyl containing C₆-C₃₀ aromatic group(s), wherein the bonds are directly connected to an aromatic moiety. The —O—Ar—O— groups in formula (B) can be, for example, a C₆-C₃₀ dihydroxyaromatic compound. Combinations comprising at least one of the foregoing dihydroxyaromatic compounds can also be used. Exemplary dihydroxyaromatic compounds are 1,1-bis(4-hydroxyphenyl) methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulfide), 1,1-bis(4-hydroxy-3-methylphenyl)cyclohexane, and 1,1-bis(4-hydroxy-t-butylphenyl)propane, or a combination comprising at least one of the foregoing dihydroxy compounds.

Polycarbonates comprising such units can be derived from the corresponding dihydroxy compound of formula (C):

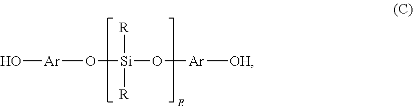

wherein Ar and E are as described above. Compounds of formula (C) can be obtained by the reaction of a dihydroxyaromatic compound with, for example, an alpha, omega-bis-acetoxy-polydiorganosiloxane oligomer under phase transfer conditions. Compounds of formula (C) can also be obtained from the condensation product of a dihydroxyaromatic compound, with, for example, an alpha, omega bis-chloro-polydimethylsiloxane oligomer in the presence of an acid scavenger.

In a further aspect, polydiorganosiloxane blocks can comprise units of formula (D):

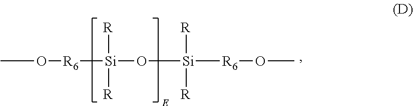

wherein R and E are as described above, and each R₆ is independently a divalent C₁-C₃₀ organic group such as a C₁-C₃₀ alkyl, C₆-C₃₀ aryl or C₇-C₃₀ alkylaryl. The polysiloxane blocks corresponding to formula (D) are derived from the corresponding dihydroxy compound of formula (E):

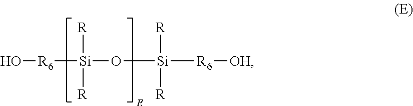

wherein R and E and R₆ are as described for formula (D) above.

In various aspects, the polycarbonate-polysiloxane copolymer can be a block copolymer comprising one or more polycarbonate blocks and one or more polysiloxane blocks. The polysiloxane-polycarbonate copolymer can comprise polydiorganosiloxane blocks comprising structural units of the general formula (I) below:

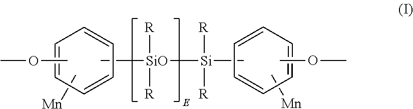

wherein the polydiorganosiloxane block length (E) is from about 20 to about 60; wherein each R group can be the same or different, and is selected from a C₁₋₁₃ monovalent organic group; wherein each M can be the same or different, and is selected from a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₂-C₁₂ aralkyl, C₇-C₁₂aralkoxy, C₇-C₁₂ alkylaryl, or C₇-C₁₂ alkylaryloxy, and where each n is independently 0, 1, 2, 3, or 4.

The polysiloxane-polycarbonate copolymer also comprises polycarbonate blocks comprising structural units of the general formula (II) below:

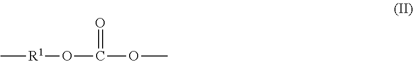

wherein at least 60 percent of the total number of R¹ groups comprise aromatic moieties and the balance thereof comprise aliphatic, alicyclic, or aromatic moieties.

According to exemplary non-limiting aspects of the disclosure, the polycarbonate-polysiloxane block copolymer comprises diorganopolysiloxane blocks of the general formula (III) below:

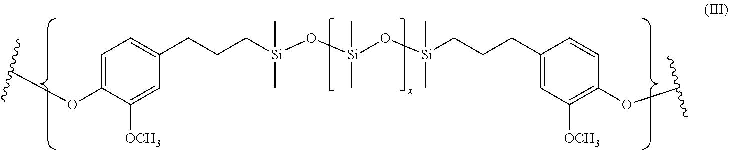

wherein x represents an integer from about 20 to about 60. The polycarbonate blocks according to these aspects can be derived from bisphenol-A monomers.

Diorganopolysiloxane blocks of formula (III) above can be derived from the corresponding dihydroxy compound of formula (IV):

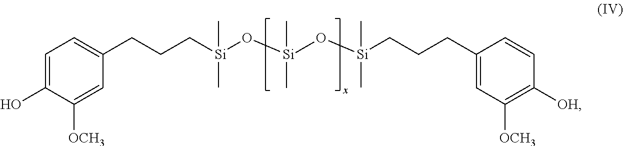

wherein x is as described above. Compounds of this type and others are further described in U.S. Pat. No. 4,746,701 to Kress, et al and U.S. Pat. No. 8,017,0697 to Carrillo. Compounds of this formula can be obtained by the reaction of the appropriate dihydroxyarylene compound with, for example, an alpha, omega-bisacetoxypolydiorangonosiloxane under phase transfer conditions.

Such dihydroxy polysiloxanes can be made by effecting a platinum catalyzed addition between a siloxane hydride of the formula (V):

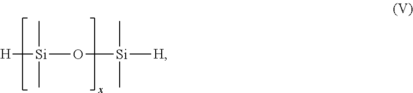

wherein x is a previously defined, and an aliphatically unsaturated monohydric phenol such as eugenol to yield a compound of formula (IV).

The polycarbonate-polysiloxane copolymer can be manufactured by reaction of a diphenolic polysiloxane, such as that depicted by formula (IV), with a carbonate source and a dihydroxy aromatic compound such as bisphenol-A, optionally in the presence of a phase transfer catalyst as described above. Suitable conditions are similar to those useful in forming polycarbonates. For example, the copolymers can be prepared by phosgenation at temperatures from below 0° C. to about 100° C., including for example, at temperatures from about 25° C. to about 50° C. Since the reaction is exothermic, the rate of phosgene addition can be used to control the reaction temperature. The amount of phosgene required will generally depend upon the amount of the dihydric reactants. Alternatively, the polycarbonate-polysiloxane copolymers can be prepared by co-reacting, in a molten state, the dihydroxy monomers and a diaryl carbonate ester, such as diphenyl carbonate, in the presence of a transesterification catalyst as described above.

In the production of the polycarbonate-polysiloxane copolymer, the amount of dihydroxy diorganopolysiloxane can be selected so as to provide the desired amount of diorganopolysiloxane units in the copolymer. The particular amounts used will therefore be determined depending on desired physical properties of the composition, the value of x (for example, within the range of about 20 to about 60), and the type and relative amount of each component in the composition, including the type and amount of polycarbonate, type and amount of polycarbonate-polysiloxane copolymer, and type and amount of any other additives. Suitable amounts of dihydroxy diorganopolysiloxane can be determined by one of ordinary skill in the art without undue experimentation using the guidelines taught herein.

For example, according to aspects of the disclosure, the polysiloxane-polycarbonate block copolymer can be provided having any desired level of siloxane content. For example, the siloxane content can be in the range of from 4 mol % to 20 mol %. In additional aspects, the siloxane content of the polysiloxane-polycarbonate block copolymer can be in the range of from 4 mol % to 10 mol %. In still further aspects, the siloxane content of the polysiloxane-polycarbonate block copolymer can be in the range of from 4 mol % to 8 mol %. In a further aspect, the polysiloxane-polycarbonate copolymer comprises a diorganosiloxane content in the range of from 5 to 7 mole wt %. In an even further exemplary aspect, the siloxane content of the polysiloxane-polycarbonate block copolymer can be about 6 mol %. Still further, the diorganopolysiloxane blocks can be randomly distributed in the polysiloxane-polycarbonate block copolymer.

In various aspects, the polysiloxane-polycarbonate block copolymer has a refractive index of greater than 1.55. In a further aspect, the polysiloxane-polycarbonate block copolymer has a refractive index of greater than 1.56. In a still further aspect, the polysiloxane-polycarbonate block copolymer has a refractive index of greater than 1.57. In a yet further aspect, the polysiloxane-polycarbonate block copolymer has a refractive index of greater than 1.58. In an even further aspect, the polysiloxane-polycarbonate block copolymer has a refractive index of greater than 1.59.

In a further aspect, the polysiloxane-polycarbonate block copolymer has a refractive index of greater than about 1.580. In a still further aspect, the polysiloxane-polycarbonate block copolymer has a refractive index of greater than about 1.581. In a yet further aspect, the polysiloxane-polycarbonate block copolymer has a refractive index of greater than about 1.582. In an even further aspect, the polysiloxane-polycarbonate block copolymer has a refractive index of greater than about 1.583. In a still further aspect, the polysiloxane-polycarbonate block copolymer has a refractive index of greater than about 1.584. In a yet further aspect, the polysiloxane-polycarbonate block copolymer has a refractive index of greater than about 1.585. In an even further aspect, the polysiloxane-polycarbonate block copolymer has a refractive index of greater than about 1.586. In a still further aspect, the polysiloxane-polycarbonate block copolymer has a refractive index of greater than about 1.587. In a yet further aspect, the polysiloxane-polycarbonate block copolymer has a refractive index of greater than about 1.588. In an even further aspect, the polysiloxane-polycarbonate block copolymer has a refractive index of greater than about 1.589.

In a further aspect, the polysiloxane-polycarbonate block copolymer has a refractive index of about 1.580. In a still further aspect, the polysiloxane-polycarbonate block copolymer has a refractive index of about 1.581. In a yet further aspect, the polysiloxane-polycarbonate block copolymer has a refractive index of about 1.582. In an even further aspect, the polysiloxane-polycarbonate block copolymer has a refractive index of about 1.583. In a still further aspect, the polysiloxane-polycarbonate block copolymer has a refractive index of about 1.584. In a yet further aspect, the polysiloxane-polycarbonate block copolymer has a refractive index of about 1.585. In an even further aspect, the polysiloxane-polycarbonate block copolymer has a refractive index of about 1.586. In a still further aspect, the polysiloxane-polycarbonate block copolymer has a refractive index of about 1.587. In a yet further aspect, the polysiloxane-polycarbonate block copolymer has a refractive index of about 1.588. In an even further aspect, the polysiloxane-polycarbonate block copolymer has a refractive index of about 1.589.

The disclosed polysiloxane-polycarbonate block copolymers can also be end-capped as similarly described in connection with the manufacture of polycarbonates set forth herein. For example, according to aspects of the disclosure, a polysiloxane-polycarbonate block copolymer can be end capped with p-cumyl-phenol.

Useful polycarbonate-polysiloxane copolymers are commercially available and include, but are not limited to, those marketed under the trade name LEXAN® EXL polymers, and are available from SABIC Innovative Plastics (formerly GE Plastics), including blends of LEXAN® EXL polymers with different properties.

### Reinforcing Filler

The disclosed polymer composition further comprises one or more reinforcing fillers. The reinforcing filler can be selected to impart additional impact strength, to improve transparency and/or provide additional characteristics that can be based on the final selected characteristics of the polymer composition. The specific composition of a reinforcing filler can vary, provided that the filler is chemically compatible with the remaining components of the polymer composition.

In one aspect, the reinforcing filler has a refractive index “n” that is at least substantially similar to a refractive index of the polycarbonate polymer component of the disclosed composition. In another aspect, the reinforcing filler has a refractive index that is at least substantially similar to a refractive index “n” of the polycarbonate polysiloxane copolymer.

In one aspect, the reinforcing filler can be present in the blended thermoplastic composition in any desired amount. In another aspect, the reinforcing filler can be present in an amount from about 5 wt % to about 50 weight %, including exemplarily values of about 6 weight %, 7 weight %, 8 weight %, 9 weight %, 10 weight %, 11 weight %, 12 weight %, 13 weight %, 14 weight %, 15 weight %, 16 weight %, 17 weight %, 18 weight %, 19 weight %, 20 weight %, 21 weight %, 22 weight %, 23 weight %, 24 weight %, 25 weight %, 26 weight %, 27 weight %, 28 weight %, 29 weight %, 30 weight %, 31 weight %, 32 weight %, 33 weight %, 34 weight %, 35 weight %, 36 weight %, 37 weight %, 38 weight %, 39 weight %, 40 weight %, 41 weight %, 42 weight %, 43 weight %, 44 weight %, 45 weight %, 46 weight %, 47 weight %, 48 weight %, and 49 weight %. In still further aspects, the reinforcing filler can be present in an amount in any range derived from any two values set forth above. For example, the reinforcing filler can be present in an amount from about 10 wt % to about 40 weight %, from about 15 wt % to about 40 weight %, or from about 20 wt % to about 35 weight %.

In one aspect, the reinforcing filler can comprise glass fibers, (including continuous and chopped fibers), including but not limited to E, A, C, ECR, R, S, D, and NE glasses and quartz, glass spheres including but not limited to hollow and solid glass spheres, glass flakes, and the like. In a yet further aspect, the inorganic filler comprises a glass fiber, wherein the glass fiber has a cross section that can be round or flat.

In one aspect, examples of suitable glass materials are C glass [SiO₂ (65-70%), AI₂O₃ (2-6%), CaO (4-9%), MgO (0-5%), B₂O₃ (2-7%), Na₂O & K₂O (9-13%), ZnO (1-6%)] and ECR glass [SiO₂ (63-70%), AI₂O₃ (3-6%), CaO (4-7%), MgO (1-4%), B₂O₃ (2-5%), Na₂O (9-12%), K₂O (0-3%), TiO₂ (0-4%), ZnO (1-5%)]. An especially preferred glass material is ECR glass having >0.1% TiO₂, especially below 1% TiO₂.

In one aspect, the reinforcing filler in the disclosed composition comprises a high refractive index ECR glass. In another aspect, the glass fiber, for example, can be Nittobo (flat) glass fiber, CSG3PA820. In an even further aspect, the glass bead has a cross section that is round or flat.

In one aspect, the glass fiber reinforcing filler can have a refractive index “n” of about 1.42 to about 1.60, including exemplarily values of 1.43, 1.44, 1.45, 1.46, 1.47, 1.48, 1.49, 1.50, 1.51, 1.52, 1.53, 1.54, 1.55, 1.56, 1.57, 1.58, and 1.59. In still further aspects, the glass fiber reinforcing filler can have a refractive index in any range derived from any two values set forth above. For example, the refractive index can be about 1.45 to about 1.60, from about 1.50 to about 1.59, or from about 1.55 to about 1.59.

In various aspects, the glass fiber reinforcing filler has a refractive index of greater than 1.55. In a further aspect, the glass fiber reinforcing filler has a refractive index of greater than 1.56. In a still further aspect, the glass fiber reinforcing filler has a refractive index of greater than 1.57. In a yet further aspect, the glass fiber reinforcing filler has a refractive index of greater than 1.57. In an even further aspect, the glass fiber reinforcing filler has a refractive index of greater than 1.59.

In a further aspect, the glass fiber reinforcing filler has a refractive index of greater than about 1.570. In a still further aspect, the glass fiber reinforcing filler has a refractive index of greater than about 1.571. In a yet further aspect, the glass fiber reinforcing filler has a refractive index of greater than about 1.572. In an even further aspect, the glass fiber reinforcing filler has a refractive index of greater than about 1.573. In a still further aspect, the glass fiber reinforcing filler has a refractive index of greater than about 1.574. In a yet further aspect, the glass fiber reinforcing filler has a refractive index of greater than about 1.575. In an even further aspect, the glass fiber reinforcing filler has a refractive index of greater than about 1.576. In a still further aspect, the glass fiber reinforcing filler has a refractive index of greater than about 1.577. In a yet further aspect, the glass fiber reinforcing filler has a refractive index of greater than about 1.578. In an even further aspect, the glass fiber reinforcing filler has a refractive index of greater than about 1.579.

In a further aspect, the glass fiber reinforcing filler has a refractive index of about 1.570. In a still further aspect, the glass fiber reinforcing filler has a refractive index of about 1.571. In a yet further aspect, the glass fiber reinforcing filler has a refractive index of about 1.572. In an even further aspect, the glass fiber reinforcing filler has a refractive index of about 1.573. In a still further aspect, the glass fiber reinforcing filler has a refractive index of about 1.574. In a yet further aspect, the glass fiber reinforcing filler has a refractive index of about 1.575. In an even further aspect, the glass fiber reinforcing filler has a refractive index of about 1.576. In a still further aspect, the glass fiber reinforcing filler has a refractive index of about 1.577. In a yet further aspect, the glass fiber reinforcing filler has a refractive index of about 1.578. In an even further aspect, the glass fiber reinforcing filler has a refractive index of about 1.579.

### Flame Retardant

In one aspect, the blended thermoplastic compositions of the present disclosure can comprise a flame retardant, wherein the flame retardant can comprise any flame retardant material or mixture of flame retardant materials suitable for use in the inventive polymer compositions.

In a further aspect, the flame retardant is a phosphorus-containing flame retardant. In a still further aspect, the flame retardant is selected from an oligomeric phosphate flame retardant, polymeric phosphate flame retardant, an aromatic polyphosphate flame retardant, oligomeric phosphonate flame retardant, phenoxyphosphazene oligomeric flame retardant, and mixed phosphate/phosphonate ester flame retardant compositions, or combinations thereof. In a yet further aspect, the phosphorus-containing flame retardant is selected from a phosphine, a phosphine oxide, a bisphosphine, a phosphonium salt, a phosphinic acid salt, a phosphoric ester, and a phosphorous ester, or mixtures thereof.

In a further aspect, the blended thermoplastic compositions comprise a flame retardant that is a non-brominated and non-chlorinated phosphorous-containing compound such as an organic phosphate. Exemplary organic phosphates can include an aromatic phosphate of the formula (GO)₃P═O, wherein each G is independently an alkyl, cycloalkyl, aryl, alkaryl, or aralkyl group, provided that at least one G is an aromatic group. Two of the G groups can be joined together to provide a cyclic group, for example, diphenyl pentaerythritol diphosphate, which is described by Axelrod in U.S. Pat. No. 4,154,775. Other suitable aromatic phosphates can be, for example, phenyl bis(dodecyl)phosphate, phenyl bis(neopently)phosphate, phenyl bis(3,5,5′-trimethylhexyl)phosphate, ethyl diphenyl phosphate, 2-ethylhexyl di(p-tolyl)phosphate, bis(2-ethylhexyl)p-tolyl phosphate, tritolyl phosphate, bis(2-ethylhexyl)phenyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

In a further aspect, di- or polyfunctional aromatic phosphorous-containing compounds can also be present. Examples of suitable di- or polyfunctional aromatic phosphorous-containing compounds include triphenyl phosphate (TPP), resorcinol tetraphenyl diphosphate (RDP), the bis(diphenyl)phosphate of hydroquinone and the bis(diphenyl)phosphate of bisphenol-A, respectively, their oligomeric and polymeric counterparts, and the like.

In a further aspect, the flame retardant can be an organic compounds containing phosphorous-nitrogen bonds. For example, phosphonitrilic chloride, phosphorous ester amides, phosphoric acid amides, phosphonic acid amides, phosphinic acid amides, tris(aziridinyl)phosphine oxide, or the like. In one aspect, a phenoxyphosphazene is used as a flame retardant.

Exemplary flame retardants include aromatic cyclic phosphazenes having a structure represented by the formula:

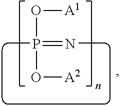

wherein each of A¹ and A² is independently an aryl group having 6 to 10 carbon atoms substituted with 0 to 4 C1-C4 alkyl groups; and n is an integer of 3 to 6. The aryl group of A¹ and A² means an aromatic hydrocarbon group having 6 to 10 atoms. Examples of such groups include phenyl and naphthyl groups. In a further aspect, the aryl group of A¹ and A² is independently selected from phenyl and naphthyl. In a still further aspect, the aryl group of A¹ and A² is phenyl. In a further aspect, aromatic cyclic phosphazene compound is a mixture of compounds represented by the foregoing formula, comprising a mixture of compounds with n=3, n=4, n=5, and n=6.

The “aryl group having 6 to 10 carbon atoms” can be substituted with 0 to 4 C1-C4 alkyl groups, wherein the alkyl group means a straight or branched saturated hydrocarbon group having 1 to 4 carbon atoms. Examples of the group include a methyl group, an ethyl group, a propyl group, an isopropyl group, a butyl group, an isobutyl group, a sec-butyl group, and a tert-butyl group. In various further aspects, the alkyl group has 1 to 3 carbon atoms. In a still further aspect, the alkyl group is methyl.

In a further aspect, each of A¹ and A² is a phenyl group, wherein each of A¹ and A² is independently substituted with 0 to 4 C1-C4 alkyl groups. In a still further aspect, each of A¹ and A² is a phenyl group, wherein each of A¹ and A² is independently substituted with 0 to 4 C1-C3 alkyl groups. In a yet further aspect, each of A¹ and A² is a phenyl group independently substituted with 0 to 4 methyl groups. In an even further aspect, each of A¹ and A² is independently selected from phenyl, o-tolyl, p-tolyl, and m-tolyl.

In various further aspects, three to six A¹ groups are present, wherein each A¹ group can be the same as or different from each other. In a further aspect, three to six A¹ groups are present, wherein each A¹ group is the same.

In various further aspects, three to six A² groups are present, wherein each A² group can be the same as or different from each other. In a further aspect, three to six A² groups are present, wherein each A² group is the same. In a yet further aspect, each A¹ and each A² are the same moiety.

In a further aspect, aromatic cyclic phosphazenes useful in the present disclosure are compounds having a structure represented by the formula:

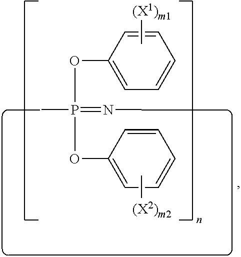

wherein each occurrence of X¹ and X² is independently a C1-C4 alkyl group; wherein each of m1 and m2 is independently an integer of 0 to 4; and wherein n is an integer of 3 to 6. As described above, alkyl group means a straight or branched saturated hydrocarbon group having 1 to 4 carbon atoms. Examples of the group include a methyl group, an ethyl group, a propyl group, an isopropyl group, a butyl group, an isobutyl group, a sec-butyl group, and a tert-butyl group. In various further aspects, the alkyl group has 1 to 3 carbon atoms. In a still further aspect, the alkyl group is methyl. In a further aspect, each of m1 and m2 is independently an integer of 0 to 3. In a still further aspect, each of m1 and m2 is independently an integer of 0 to 2. In a yet further aspect, each of m1 and m2 is independently an integer that is 0 or 1. In an even further aspect, each of m1 and m2 is 0. In a still further aspect, each of m1 and m2 is 1.

In various further aspects, three to six X¹ groups are present, wherein each X¹ group can be the same as or different from each other. In a further aspect, three to six X¹ groups are present, wherein each X¹ group is the same.

In various further aspects, three to six X² groups are present, wherein each X² group can be the same as or different from each other. In a further aspect, three to six X² groups are present, wherein each X² group is the same. In a yet further aspect, each X¹ and each X² are the same moiety.

In various further aspects, the aromatic cyclic phosphazene is a compound selected from Examples of the compound represented by General Formula (I) include 2,2,4,4,6,6-hexaphenoxycyclotriphosphazene, 2,2,4,4,6,6-hexakis(p-tolyloxy)cyclotriphosphazene, 2,2,4,4,6,6-hexakis(m-tolyloxy)cyclotriphosphazene, 2,2,4,4,6,-hexakis(o-tolyloxy)cyclotriphosphazene, 2,4,6-triphenoxy-2,4,6-tris(p-tolyloxy)cyclotriphosphazene, 2,4,6-triphenoxy-2,4,6-tris(m-tolyloxy)cyclotriphosphazene, 2,4,6-triphenoxy-2,4,6-tris(o-tolyloxy)cyclotriphosphazene, 2,4,6-triphenoxy-2,4,6-tris(2-ethylphenoxy)cyclotriphosphazene, 2,4,6-triphenoxy-2,4,6-tris(3-ethylphenoxy)cyclotriphosphazene, 2,4,6-triphenoxy-2,4,6-tris(4-ethylphenoxy)cyclotriphosphazene, 2,4,6-triphenoxy-2,4,6-tris(2,3-xylyloxy)cyclotriphosphazene, 2,4,6-triphenoxy-2,4,6-tris(2,4-xylyloxy)cyclotriphosphazene, 2,4,6-triphenoxy-2,4,6-tris(2,5-xylyloxy)cyclotriphosphazene, 2,4,6-triphenoxy-2,4,6-tris(2,6-xylyloxy)cyclotriphosphazene, 2,4,6-triphenoxy-2,4,6-tris(3,4-xylyloxy)cyclotriphosphazene, 2,4,6-triphenoxy-2,4,6-tris(3,5-xylyloxy)cyclotriphosphazene, 2,2,4,4,6,6,8,8-octaphenoxycyclotetraphosphazene, 2,2,4,4,6,6,8,8-octakis(p-tolyloxy)cyclotetraphosphazene, 2,2,4,4,6,6,8,8-octakis(m-tolyloxy)cyclotetraphosphazene, 2,2,4,4,6,6,8,8-octakis(o-tolyloxy)cyclotetraphosphazene, 2,4,6,8-tetraphenoxy-2,4,6,8-tetrakis(p-tolyloxy)cyclotetraphosphazene, 2,4,6,8-tetraphenoxy-2,4,6,8-tetrakis(m-tolyloxy)cyclotetraphosphazene, and 2,4,6,8-tetraphenoxy-2,4,6,8-tetrakis(o-tolyloxy)cyclotetraphosphazene. In a still further aspect, the aromatic cyclic phosphazene is selected from 2,2,4,4,6,6-hexaphenoxycyclotriphosphazene, 2,4,6-triphenoxy-2,4,6-tris(p-tolyloxy)cyclotriphosphazene, 2,4,6-triphenoxy-2,4,6-tris(m-tolyloxy)cyclotriphosphazene, and 2,4,6-triphenoxy-2,4,6-tris(o-tolyloxy)cyclotriphosphazene.

In a further aspect, the aromatic cyclic phosphazene comprises at least one compound represented by one of the phosphazene formulas described herein as a main component. In various aspects, the content of the aromatic cyclic phosphazene composition is about 90 wt %. In a further aspect, the content of the aromatic cyclic phosphazene composition is about 95 wt %. In a still further aspect, the content of the aromatic cyclic phosphazene composition is about 100 wt %.

Other components in the aromatic cyclic phosphazene composition are not specifically limited as long as the object of the present disclosure is not impaired. Aromatic cyclic phosphazene-containing flame retardant useful in the present disclosure are commerically available. Suitable examples of such commercial products include “Rabitle FP-110” and “Rabitle FP-390” manufactured by FUSHIMI Pharmaceutical Co., Ltd.

In a further aspect, the phosphorus-containing flame retardant is selected from a phosphine, a phosphine oxide, a bisphosphine, a phosphonium salt, a phosphinic acid salt, a phosphoric ester, and a phosphorous ester.

In a further aspect, the phosphorus-containing flame retardant is selected from rescorcinol bis(diphenyl phosphate), resorcinol bis(dixylenyl phosphate), hydroquinone bis(diphenyl phosphate), bisphenol-A bis(diphenyl phosphate), 4,4′-biphenol bis(diphenyl phosphate), triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate and dipyrocatechol hypodiphosphate. In a still further aspect, the flame retardant is selected from triphenyl phosphate; cresyldiphenylphosphate; tri(isopropylphenyl)phosphate; resorcinol bis(diphenylphosphate); and bisphenol-A bis(diphenyl phosphate). In a yet further aspect, resorcinol bis(biphenyl phosphate), bisphenol A bis(diphenyl phosphate) hydroquinone bis(diphenyl phosphate), phosphoric acid, 1,3-phenylene tetraphenyl ester), bis-phenol-A bis-diphenyl phosphate) or mixtures thereof. In an even further aspect, the flame retardant is bisphenol-A bis(diphenyl phosphate). In a still further aspect, the phosphorus-containing flame retardant is selected from resorcinol bis(biphenyl phosphate), bisphenol A bis(diphenyl phosphate), and hydroquinone bis(diphenyl phosphate), or mixtures thereof. In yet a further aspect, the phosphorus-containing flame retardant is bisphenol A bis(diphenyl phosphate). In an even further aspect, the phosphorus-containing flame retardant is resorcinol bis(biphenyl phosphate).

In a further aspect, the flame retardant is present in an amount from greater than about 1 wt % to about 15 wt %. In a still further aspect, the flame retardant is present in an amount from greater than about 2 wt % to about 12 wt %. In a yet further aspect, the flame retardant is present in an amount from greater than about 3 wt % to about 10 wt %. In an even further aspect, the flame retardant is present in an amount from greater than about 3 wt % to about 7 wt %.

In one aspect, the flame retardant in the disclosed blended thermoplastic composition can be present in any desirable amount. In another aspect, the flame retardant can be present in an amount from about 3 wt % to about 7 weight %, including exemplarily values of about 3.2 weight %, 3.4 weight %, 3.6 weight %, 3.8 weight %, 4 weight %, 4.2 weight %, 4.4 weight %, 4.6 weight %, 4.8 weight %, 5 weight %, 5.2 weight %, 5.4 weight %, 5.6 weight %, 5.8 weight %, 6 weight %, 6.2 weight %, 6.4 weight %, 6.6 weight %, and 6.8 weight %. In still further aspects, the flame retardant can be present in an amount in any range derived from any two values set forth above. For example, the flame retardant can be present in an amount from about 3.5 wt % to about 6.5 weight %, from about 4 wt % to about 7 weight %, or from about 5 wt % to about 7 weight %.

In various aspects, the phosphorus-containing flame retardant comprises a first flame retardant and a second flame retardant.

In a further aspect, the phosphorus-containing flame retardant comprises a first flame retardant and a second flame retardant; wherein the first flame retardant selected from selected from rescorcinol bis(diphenyl phosphate), resorcinol bis(dixylenyl phosphate), hydroquinone bis(diphenyl phosphate), bisphenol-A bis(diphenyl phosphate), 4,4′-biphenol bis(diphenyl phosphate), triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate and dipyrocatechol hypodiphosphate; and wherein the second flame retardant is an aromatic cyclic phosphazene compound has a structure represented by the formula:

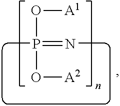

wherein each of A¹ and A² is independently an aryl group having 6 to 10 carbon atoms optionally substituted with 1 to 4 alkyl groups having 1 to 4 carbon atoms; and wherein n is an integer of 3 to 6.

In a further aspect, the first flame retardant selected from selected from rescorcinol bis(diphenyl phosphate), resorcinol bis(dixylenyl phosphate), bisphenol-A bis(diphenyl phosphate), and 4,4′-biphenol bis(diphenyl phosphate); and wherein the second flame retardant is an aromatic cyclic phosphazene compound has a structure represented by the formula:

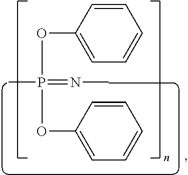

wherein n is 3 to 6.

### Flame Retardant Synergist

The disclosed blended thermoplastic composition further comprises a flame retardant synergist which, as exemplified in the appended examples, further improves flame retardancy of the composition comprising a flame retardant comprising an organophosphorous compound without affecting mechanical and optical properties of the composition. To that end, this improvement is evidenced by the disclosed blended thermoplastic compositions having flame retardancy ratings of V0 at 1.5 mm and 1.2 mm thickness as compared to the compositions having a conventional non-phosphorous containing flame retardant. Addition of the flame retardant synergist does not improve flame retardancy of the composition comprising conventional non-phosphorous containing flame retardant. Without wishing to be bound by any theory it can be speculated that a phosphorous containing flame retardant and a flame retardant synergist, disclosed herein, have a synergistic effect on the overall flammability performance of the disclosed composition.

According to aspects of the disclosure, suitable flame retardant synergists comprise siloxane oils. Exemplary siloxane oils comprise a polymethylphenyl siloxane, a dimethyl diphenyl methyl hydrogen silicone oil, or a combination thereof. In one aspect, the flame retardant synergist comprises a polymethyphenyl siloxane. In another aspect, the flame retardant synergist comprises a dimethyl diphenyl methyl hydrogen silicone oil. In a further aspect, the flame retardant synergist can comprise a polymethyphenyl siloxane, a dimethyl diphenyl methyl hydrogen silicone oil or any combinations thereof. In various aspects, the siloxane oil is selected from a methyl hydrogen polysiloxane and a poly(silane/chlor-methyl). In a further aspect, the flame retardant synergists comprises a polyorganosiloxane such as polymethylphenylsiloxane, poly(dimethyl-diphenyl-methylhydrogen)siloxane, poly dimethyl diphenyl siloxane, poly(methylethylsiloxane), poly(dimethylsiloxane), polymethylphenylsiloxane, poly(diphenylsiloxane), polydiethylsiloxane, polyethylphenylsiloxane, and resin or oil mixture thereof.

In various aspects, the term “silicone oil” as used herein is generic for a wide range of polysiloxane materials which can advantageously be utilized in the compositions of the present disclosure. For purposes of the present disclosure it is intended that the expression “silicone oil” can be construed as including those effective silicone materials as described in U.S. Pat. No. 4,273,691, which is incorporated herein in its entirety by reference, as well as other effective silicone oil materials. In a further aspect, the silicone oils can be organopolysiloxane polymers comprised of chemically combined siloxyl units typically selected from the group consisting of R₃SiO_{0.5}, R₂SiO, R¹SiO_{1.5}, R¹R₂SiO_{0.5}, RR¹SiO, (R¹)₂SiO, RSiO_{1.5}, and SiO₂ units and mixtures thereof wherein each R represents independently a saturated or unsaturated monovalent hydrocarbon radical, R¹ represents a radical such as R or a radical selected from the group consisting of a hydrogen atom, hydroxyl, alkoxy, aryl, vinyl, or allyl radicals etc. In a still further aspect, the organopolysiloxane has a viscosity of approximately 600 to 300,000,000 centipoise at 25° C. In a yet further aspect, the polyorganosiloxane is a polydimethylsiloxane having a viscosity of approximately 90,000 to 150,000 centipoise at 25° C. Such silicone oils are readily available under a wide variety of brand and grade designations.

Exemplary siloxane oils suitable for use in the blended thermoplastic compositions of the present disclosure are commercially available under a variety of trade names, including, but not limited to, KF-9901 (Shin-Etsu Chemical Co., Ltd.); KR-2710, a dimethyl diphenyl methyl hydrogen silicone oil (Shin-Etsu Chemical Co., Ltd.); X-40-9805, a methyl phenyl silicone resin (Shin-Etsu Chemical Co., Ltd.); methylphenylpolysiloxanes such as TSF-431, TSF-433, and TSF-437 (GE Toshiba Silicones Co., Ltd.); and a silicone alkoxy oligomer comprising phenyl and alkoxysilyl groups without silanol group such as KR-480 (Shin-Etsu Chemical Co., Ltd.).

According to further aspects, the disclosed blended thermoplastic composition can further comprise a flame retardant synergist. In one aspect, the flame retardant synergist can comprise any material that improves a flame retardancy of the disclosed composition. In another aspect, the flame retardant synergist can comprise siloxane oil. In a further aspect, the siloxane oil can comprise a polymethylphenyl siloxane, or dimethyl diphenyl methyl hydrogen silicone oil, or a combination thereof.

In one aspect, the flame retardant synergist can be present in the blended thermoplastic composition in any desirable amount. In one aspect, the flame retardant synergist can be present in an amount from about 0.5 wt % to about 5 weight %, including exemplarily values of 0.6 weight %, 0.7 weight %, 0.8 weight %, 0.9 weight %, 1.0 weight %, 1.1 weight %, 1.2 weight %, 1.3 weight %, 1.4 weight %, 1.5 weight %, 1.6 weight %, 1.7 weight %, 1.8 weight %, 1.9 weight %, 2.0 weight %, 2.1 weight %, 2.2 weight %, 2.3 weight %, 2.4 weight %, 2.5 weight %, 2.6 weight %, 2.7 weight %, 2.8 weight %, 2.9 weight %, 3.0 weight %, 3.1 weight %, 3.2 weight %, 3.3 weight %, 3.4 weight %, 3.5 weight %, 3.6 weight %, 3.7 weight %, 3.8 weight %, 3.9 weight %, 4.0 weight %, 4.1 weight %, 4.2 weight %, 4.3 weight %, 4.4 weight %, 4.5 weight %, 4.6 weight %, 4.7 weight %, 4.8 weight %, and 4.9 weight %. In still further aspects, the flame retardant synergist can be present in an amount in any range derived from any two values set forth above. For example, the flame retardant synergist can be present in an amount from about 0.5 wt % to about 4.5 weight %, from about 1 wt % to about 4.0 weight %, or from about 1.5 wt % to about 3 weight %.

### Optional Polymer Composition Additives

In addition to the foregoing components, the disclosed blended thermoplastic compositions can optionally comprise a balance amount of one or more additive materials ordinarily incorporated in polycarbonate resin compositions of this type, with the proviso that the additives are selected so as to not significantly adversely affect the desired properties of the polycarbonate composition. Combinations of additives can be used. Such additives can be mixed at a suitable time during the mixing of the components for forming the composition. Exemplary and non-limiting examples of additive materials that can be present in the disclosed polycarbonate compositions include an acid scavenger, anti-drip agent, antioxidant, antistatic agent, chain extender, colorant (e.g., pigment and/or dye), de-molding agent, flow promoter, lubricant, mold release agent, plasticizer, quenching agent, stabilizer (including for example a thermal stabilizer, a hydrolytic stabilizer, or a light stabilizer), UV absorbing additive, and UV reflecting additive, or any combination thereof.

In a further aspect, the disclosed blended thermoplastic compositions can further comprise a primary antioxidant or “stabilizer” (e.g., a hindered phenol) and, optionally, a secondary antioxidant (e.g., a phosphate and/or thioester). Suitable antioxidant additives include, for example, organic phosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

In a further aspect, the antioxidant is a primary antioxidant, a secondary antioxidant, or combinations thereof. In a still further aspect, the primary antioxidant is selected from a hindered phenol and secondary aryl amine, or a combination thereof. In yet a further aspect, the hindered phenol comprises one or more compounds selected from triethylene glycol bis[3-(3-t-butyl-5-methyl-4-hydroxyphenyl)propionate], 1,6-hexanediolbis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate. In an even further aspect, the hindered phenol comprises octadecyl-3-(3,5-di-t-butyl-4-hydroxyphenyl)-propionate.

In a further aspect, the secondary anti-oxidant is selected from an organophosphate and thioester, or a combination thereof. In a still further aspect, the secondary anti-oxidant comprises one or more compounds selected from tetrakis(2,4-di-tert-butylphenyl) [1,1-biphenyl]-4,4′-diylbisphosphonite, tris(2,4-di-tert-butylphenyl)phosphite, bis(2,4-di-tert-butylphenyl)pentaerythritol diphosphite, bis(2,4-dicumylphenyl)pentaerytritoldiphosphite, tris(nonyl phenyl)phosphite, and distearyl pentaerythritol diphosphite. In yet a further aspect, the secondary anti-oxidant comprises tris(2,4-di-tert-butylphenyl)phosphite.

Antioxidants are generally used in amounts of about 0.01 wt % to about 3 wt %, optionally about 0.05 wt % to about 2.0 wt % of the blended thermoplastic composition.

In a further aspect, the primary antioxidant is present in an amount from about 0.01 wt % to about 3 wt %. In another aspect, the primary antioxidant is present in an amount from about 0.01 wt % to about 2.5 wt %. In still another aspect, the primary antioxidant is present in an amount from about 0.5 wt % to about 2.5 wt %. In yet a further aspect, the primary antioxidant is present in an amount from about 0.5 wt % to about 2.0 wt %. In still another aspect, the primary antioxidant is present in an amount from about 0.1 wt % to about 0.5 wt %. In still another aspect, the primary antioxidant is present in an amount from about 0.2 wt % to about 0.5 wt %. In still another aspect, the primary antioxidant is present in an amount from about 0.2 wt % to about 0.4 wt %.

In a further aspect, the secondary antioxidant is present in an amount from about 0.01 wt % to about 3.0 wt %. In another aspect, the secondary antioxidant is present in an amount from about 0.01 wt % to about 2.5 wt %. In still another aspect, the secondary antioxidant is present in an amount from about 0.5 wt % to about 2.5 wt %. In yet another aspect, the secondary antioxidant is present in an amount from about 0.5 wt % to about 2.0 wt %. In still another aspect, the secondary antioxidant is present in an amount from about 0.05 wt % to about 0.4 wt %. In still another aspect, the secondary antioxidant is present in an amount from about 0.05 wt % to about 0.2 wt %.

In various aspects, the disclosed blended thermoplastic compositions further comprise a hydrolytic stabilizer, wherein the hydrolytic stabilizer comprises a hydrotalcite and an inorganic buffer salt. In a further aspect, the disclosed polycarbonate blend composition comprises a hydrolytic stabilizer, wherein the hydrolytic stabilizer comprises one or more hydrotalcites and an inorganic buffer salt comprising one or more inorganic salts capable of pH buffering. Either synthetic hydrotalcites or natural hydrotalcites can be used as the hydrotalcite compound in the present disclosure. Exemplary hydrotalcites that are useful in the compositions of the present are commercially available and include, but are not limited to, magnesium hydrotalcites such as DHT-4C (available from Kyowa Chemical Co.); Hysafe 539 and Hysafe 530 (available from J. M. Huber Corporation).

In a further aspect, suitable thermal stabilizer additives include, for example, organic phosphites such as triphenyl phosphite, tris-(2,6-dimethylphenyl)phosphite, tris-(mixed mono and di-nonylphenyl)phosphite or the like; phosphonates such as dimethylbenzene phosphonate or the like, organic phosphates such as trimethyl phosphate, thioesters such as pentaerythritol betalaurylthiopropionate, and the like, or combinations comprising at least one of the foregoing thermal stabilizers.

Thermal stabilizers are generally used in amounts of about 0.01 wt % to about 5 wt %, optionally about 0.05 wt % to about 2.0 wt % of the polycarbonate blend composition. In one aspect, the thermal stabilizer is present in an amount from about 0.01 wt % to about 3.0 wt %. In another aspect, the thermal stabilizer is present in an amount from about 0.01 wt % to about 2.5 wt %. In still another aspect, the thermal stabilizer is present in an amount from about 0.5 wt % to about 2.5 wt %. In still another aspect, the thermal stabilizer is present in an amount from about 0.5 wt % to about 2.0 wt %. In still another aspect, the thermal stabilizer is present in an amount from about 0.1 wt % to about 0.8 wt %. In still another aspect, the thermal stabilizer is present in an amount from about 0.1 wt % to about 0.7 wt %. In still another aspect, the thermal stabilizer is present in an amount from about 0.1 wt % to about 0.6 wt %. In still another aspect, the thermal stabilizer is present in an amount from about 0.1 wt % to about 0.5 wt %. In still another aspect, the thermal stabilizer is present in an amount from about 0.1 wt % to about 0.4 wt %. In still another aspect, the thermal stabilizer is present in an amount from about 0.05 wt % to about 1.0 wt %.

In various aspects, plasticizers, lubricants, and/or mold release agents additives can also be used. There is a considerable overlap among these types of materials, which include, for example, phthalic acid esters such as dioctyl-4,5-epoxy-hexahydrophthalate; tris(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g. methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof; waxes such as beeswax, montan wax, paraffin wax or the like.

Blended thermoplastic composition additives such as plasticizers, lubricants, and/or mold release agents additive are generally used in amounts of about 0.01 wt % to about 20 wt %, optionally about 0.5 wt % to about 10 wt % the polycarbonate blend composition. In one aspect, the mold release agent is methyl stearate; stearyl stearate or pentaerythritol tetrastearate. In another aspect, the mold release agent is pentaerythritol tetrastearate.

In various aspects, the mold release agent is present in an amount from about 0.01 wt % to about 3.0 wt %. In another aspect, the mold release agent is present in an amount from about 0.01 wt % to about 2.5 wt %. In still another aspect, the mold release agent is present in an amount from about 0.5 wt % to about 2.5 wt %. In still another aspect, the mold release agent is present in an amount from about 0.5 wt % to about 2.0 wt %. In still another aspect, the mold release agent is present in an amount from about 0.1 wt % to about 0.6 wt %. In still another aspect, the mold release agent is present in an amount from about 0.1 wt % to about 0.5 wt %.

In a further aspect, the anti-drip agents can also be present. In a further aspect, the anti-drip agent is a styrene-acrylonitrile copolymer encapsulated polytetrafluoroethylene. Exemplary anti-drip agents can include a fibril forming or non-fibril forming fluoropolymer such as polytetrafluoroethylene (PTFE). The anti-drip agent can optionally be encapsulated by a rigid copolymer, for example styrene-acrylonitrile (SAN). PTFE encapsulated in SAN is known as TSAN. Encapsulated fluoropolymers can be made by polymerizing the encapsulating polymer in the presence of the fluoropolymer, for example, in an aqueous dispersion. TSAN can provide significant advantages over PTFE, in that TSAN can be more readily dispersed in the composition. A suitable TSAN can comprise, for example, about 50 wt % PTFE and about 50 wt % SAN, based on the total weight of the encapsulated fluoropolymer. Alternatively, the fluoropolymer can be pre-blended in some manner with a second polymer, such as for, example, an aromatic polycarbonate resin or SAN to form an agglomerated material for use as an anti-drip agent. Either method can be used to produce an encapsulated fluoropolymer.

In a further aspect, the anti-drip agent is present in an amount from about 0.01 wt % to about 3 wt %. In a still further aspect, the anti-drip agent is present in an amount from about 0.01 wt % to about 2.5 wt %. In yet a further aspect, the anti-drip agent is present in an amount from about 0.5 wt % to about 2.0 wt %.

### Methods of Manufacture

The blended thermoplastic compositions of the present disclosure can be blended with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between about 230° C. and about 350° C. in the molten resin composition, although higher temperatures can be used provided that the residence time of the resin in the processing equipment is kept short. In some embodiments the melt processed composition exits processing equipment such as an extruder through small exit holes in a die. The resulting strands of molten resin are cooled by passing the strands through a water bath. The cooled strands can be chopped into small pellets for packaging and further handling.

Compositions can be manufactured by various methods, including batch or continuous techniques that employ kneaders, extruders, mixers, and the like. For example, the composition can be formed as a melt blend employing a twin-screw extruder. In some embodiments at least some of the components are added sequentially. For example, the polycarbonate component and the impact modifier component, can be added to the extruder at the feed throat or in feeding sections adjacent to the feed throat, or in feeding sections adjacent to the feed throat, while the mineral filler component and flame retardant component can be added to the extruder in a subsequent feeding section downstream. Alternatively, the sequential addition of the components may be accomplished through multiple extrusions. A composition may be made by preextrusion of selected components, such as the polycarbonate component and the impact modifier component to produce a pelletized mixture. A second extrusion can then be employed to combine the preextruded components with the remaining components. The mineral filler component can be added as part of a masterbatch or directly. The masterbatch or the mineral filler component can be added either at the feedthroat or down stream. The extruder can be a two lobe or three lobe twin screw extruder.

In various aspects, the polycarbonate polymer component, reinforcing filler component, and the flame retardant component, and/or other optional components are first blended in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

In a further aspect, the disclosure relates to a method for making a blended thermoplastic composition comprising a) combining: i) from about 50 wt % to about 95 wt % of a polycarbonate polymer component; ii) from about 5 wt % to about 50 wt % of a reinforcing filler component; and iii) from about 3 wt % to about 7 wt % of a flame retardant component; wherein the combined weight percent value of all components does not exceed about 100 wt %; and wherein all weight percent values are based on the total weight of the composition.

As described herein, the present disclosure relates to a method of making a blended polymer composition. The polymer composition of the present disclosure can be formed using any known method of combining multiple components to form a polymer resin. In one aspect, the components are first blended in a high-speed mixer. Other low shear processes including but not limited to hand mixing can also accomplish this blending. The blend is then fed into the throat of a twin-screw extruder via a hopper. Alternatively, one or more of the components can be incorporated into the composition by feeding directly into the extruder at the throat and/or downstream through a sidestuffer. The extruder is generally operated at a temperature higher than that necessary to cause the composition to flow. The extrudate is immediately quenched in a water batch and pelletized. The pellets so prepared when cutting the extrudate can be one-fourth inch long or less as desired. Such pellets can be used for subsequent molding, shaping, or forming. In one aspect, the blend composition is formed by extrusion blending.

In one aspect, the method comprises making a blended thermoplastic composition wherein the polycarbonate polymer component can be present in the blended composition in any desired amount. For example, the polycarbonate polymer can be present in the blended thermoplastic composition in a range from about 50 wt % to about 95 weight %, including exemplary values of about 51 weight %, 52 weight %, 53 weight %, 54 weight %, 55 weight %, 56 weight %, 57 weight %, 58 weight %, 59 weight %, 60 weight %, 61 weight %, 62 weight %, 63 weight %, 64 weight %, 65 weight %, 66 weight %, 67 weight %, 68 weight %, 69 weight %, 70 weight %, 71 weight %, 72 weight %, 73 weight %, 74 weight %, 75 weight %, 76 weight %, 77 weight %, 78 weight %, 79 weight %, 80 weight %, 81 weight %, 82 weight %, 83 weight %, 84 weight %, 85 weight %, 86 weight %, 87 weight %, 88 weight %, 89 weight %, 90 weight %, 91 weight %, 92 weight %, 93 weight %, and about 94 weight %. In still further aspects, the polycarbonate polymer can be present in any range derived from any two values set forth above.

In another aspect, the method comprises making a blended polymer composition, wherein the polycarbonate polymer component comprises a linear polycarbonate, a polycarbonate-polysiloxane copolymer, or a combination thereof. In a further aspect, the disclosed method comprises making a blended polymer composition, wherein the polycarbonate polymer component comprises a bisphenol A polycarbonate polymer.

In one aspect, the method disclosed herein, comprises making a blended polymer composition, wherein the reinforcing filler can be present in the blended thermoplastic composition in any desired amount. In another aspect, the reinforcing filler can be present in an amount from about 5 wt % to about 50 weight %, including exemplarily values of about 6 weight %, 7 weight %, 8 weight %, 9 weight %, 10 weight %, 11 weight %, 12 weight %, 13 weight %, 14 weight %, 15 weight %, 16 weight %, 17 weight %, 18 weight %, 19 weight %, 20 weight %, 21 weight %, 22 weight %, 23 weight %, 24 weight %, 25 weight %, 26 weight %, 27 weight %, 28 weight %, 29 weight %, 30 weight %, 31 weight %, 32 weight %, 33 weight %, 34 weight %, 35 weight %, 36 weight %, 37 weight %, 38 weight %, 39 weight %, 40 weight %, 41 weight %, 42 weight %, 43 weight %, 44 weight %, 45 weight %, 46 weight %, 47 weight %, 48 weight %, and 49 weight %. In still further aspects, the reinforcing filler can be present in an amount in any range derived from any two values set forth above. For example, the reinforcing filler can be present in an amount from about 10 wt % to about 40 weight %, from about 15 wt % to about 40 weight %, or from about 20 wt % to about 35 weight %.

In one aspect, the method disclosed herein, comprises making a blended polymer composition, wherein the reinforcing filler present in the blended thermoplastic composition has a refractive index “n” that is at least substantially similar to a refractive index of the polycarbonate polymer component. In another aspect, the reinforcing filler has a refractive index that is at least substantially similar to a refractive index of the polycarbonate-polysiloxane polymer.

In one aspect, the method disclosed herein, comprises making a blended polymer composition, wherein the reinforcing filler can have a refractive index of about 1.42 to about 1.60, including exemplarily values of 1.43, 1.44, 1.45, 1.46, 1.47, 1.48, 1.49, 1.50, 1.51, 1.52, 1.53, 1.54, 1.55, 1.56, 1.57, 1.58, and 1.59. In still further aspects, the reinforcing filler can have a refractive index in any range derived from any two values set forth above. For example, the refractive index can be about 1.45 to about 1.60, from about 1.50 to about 1.59, or from about 1.55 to about 1.59.

In one aspect, the method disclosed herein, comprises making a blended polymer composition, wherein the reinforcing filler present in the blended thermoplastic composition can comprise a glass fiber, and wherein the glass fiber has a refractive index “n” that is at least substantially similar to a refractive index of the polycarbonate polymer component. In another aspect, the reinforcing filler can comprise a glass fiber, wherein the glass fiber has a refractive index that is at least substantially similar to a refractive index “n” of the polycarbonate-polysiloxane polymer.

In one aspect, the method disclosed herein, comprises making a blended polymer composition, wherein the glass fiber reinforcing filler can have a refractive index of about 1.42 to about 1.60, including exemplarily values of 1.43, 1.44, 1.45, 1.46, 1.47, 1.48, 1.49, 1.50, 1.51, 1.52, 1.53, 1.54, 1.55, 1.56, 1.57, 1.58, and 1.59. In still further aspects, the glass fiber reinforcing filler can have a refractive index in any range derived from any two values set forth above. For example, the refractive index can be about 1.45 to about 1.60, from about 1.50 to about 1.59, or from about 1.55 to about 1.59.

In one aspect, the method disclosed herein, comprises making a blended polymer composition, wherein the flame retardant can comprise a phosphorous containing flame retardant. In yet another aspect, the phosphorous containing flame retardant can comprise an organophosphorous compound. In a still further aspect, the organophosphorous compound can comprise a bishpenol A diphosphate polymer, or phenoxyphsophazene polymer, or a combination thereof.

In one aspect, the method disclosed herein, comprises making a blended polymer composition, wherein the flame retardant can be present in any desirable amount. In another aspect, the flame retardant can be present in an amount from about 3 wt % to about 7 weight %, including exemplarily values of about 3.2 weight %, 3.4 weight %, 3.6 weight %, 3.8 weight %, 4 weight %, 4.2 weight %, 4.4 weight %, 4.6 weight %, 4.8 weight %, 5 weight %, 5.2 weight %, 5.4 weight %, 5.6 weight %, 5.8 weight %, 6 weight %, 6.2 weight %, 6.4 weight %, 6.6 weight %, and 6.8 weight %. In still further aspects, the flame retardant can be present in an amount in any range derived from any two values set forth above. For example, the flame retardant can be present in an amount from about 3.5 wt % to about 6.5 weight %, from about 4 wt % to about 7 weight %, or from about 5 wt % to about 7 weight %.

In one aspect, the step a) of the method of making the disclosed composition can further comprise from about 0.5 wt % to about 5 wt % of a flame retardant synergist. In one aspect, the flame retardant synergist can comprise any material that improves a flame retardancy of the disclosed composition. In another aspect, the flame retardant synergist can comprise siloxane oil. In a further aspect, the siloxane oil can comprise a polymethylphenyl siloxane, or a dimethyl diphenyl methyl hydrogen silicone oil, or a combination thereof.

In one aspect, the method disclosed herein, comprises making a blended polymer composition, wherein the flame retardant synergist can be present in the blended thermoplastic composition in any desirable amount. In one aspect, the flame retardant synergist can be present in an amount from about 0.5 wt % to about 5 weight %, including exemplarily values of 0.6 weight %, 0.7 weight %, 0.8 weight %, 0.9 weight %, 1.0 weight %, 1.1 weight %, 1.2 weight %, 1.3 weight %, 1.4 weight %, 1.5 weight %, 1.6 weight %, 1.7 weight %, 1.8 weight %, 1.9 weight %, 2.0 weight %, 2.1 weight %, 2.2 weight %, 2.3 weight %, 2.4 weight %, 2.5 weight %, 2.6 weight %, 2.7 weight %, 2.8 weight %, 2.9 weight %, 3.0 weight %, 3.1 weight %, 3.2 weight %, 3.3 weight %, 3.4 weight %, 3.5 weight %, 3.6 weight %, 3.7 weight %, 3.8 weight %, 3.9 weight %, 4.0 weight %, 4.1 weight %, 4.2 weight %, 4.3 weight %, 4.4 weight %, 4.5 weight %, 4.6 weight %, 4.7 weight %, 4.8 weight %, and 4.9 weight %. In still further aspects, the flame retardant synergist can be present in an amount in any range derived from any two values set forth above. For example, the flame retardant synergist can be present in an amount from about 0.5 wt % to about 4.5 weight %, from about 1 wt % to about 4.0 weight %, or from about 1.5 wt % to about 3 weight %.

In one aspect, the method disclosed herein, comprises making a blended polymer composition, wherein the formed composition is preferably transparent. To that end, the formed composition by the methods disclosed herein can exhibit a level of transmittance that is greater than 50%, including exemplary transmittance values of at least 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89, 90%, 91%, 92%, 93%, 94%, 95%, 96%, 97%, 98%, and 99%, or any range of transmittance values derived from the above exemplified values. In still further aspects, the formed composition exhibits relatively high levels of transparency characterized by exhibiting a transmittance of at least 80%. In a still further aspect, the disclosed composition exhibits a transmittance of at least 83%. Transparency can be measured for a disclosed polymer according to ASTM method D1003 at a thickness of 2 mm.

According to aspects of the disclosure, the composition formed by the methods disclosed herein preferably exhibits a level of “haze” that is less than 80%, including haze values of less than 70%, 60%, 50%, 40%, 30%, 20%, 10%, 5%, and 1%, or any range derived from these values. In still further aspects, the formed composition exhibits relatively low levels of haze characterized by exhibiting a “haze” value that is less than or equal to 30%. Haze can be measured for a disclosed polymer according to ASTM method D1003 at a thickness of 2 mm.

In one aspect, the blended polymer composition formed by the method disclosed herein can have a flame retardancy rating of V0 at a thickness of 1.5 mm. In another aspect, the blended thermoplastic composition can have a flame retardancy rating of V0 at a thickness of 1.2 mm.

### Articles of Manufacture

In one aspect, the present disclosure pertains to shaped, formed, or molded articles comprising the blended thermoplastic compositions. The blended thermoplastic compositions can be molded into useful shaped articles by a variety of means such as injection molding, extrusion, rotational molding, blow molding and thermoforming to form articles. The blended thermoplastic compositions described herein can also be made into film and sheet as well as components of laminate systems. In a further aspect, a method of manufacturing an article comprises melt blending the polycarbonate component, the impact modifier component, the flame retardant component, and the mineral filler component; and molding the extruded composition into an article. In a still further aspect, the extruding is done with a twin-screw extruder. The articles comprising the disclosed blended thermoplastic compositions can be, but are not limited to, computer and business machine housings such as housings for high end laptop personal computers, monitors, hand held electronic device housings such as housings for smart phones, tablets, music devices electrical connectors, and components of lighting fixtures, ornaments, home appliances, and the like.

In a further aspect, the article is extrusion molded. In a still further aspect, the article is injection molded.

Formed articles include, for example, personal computers, notebook and portable computers, cell phone antennas and other such communications equipment, medical applications, RFID applications, automotive applications, and the like. In various further aspects, the article is a computer and business machine housing such as a housing for high end laptop personal computers, monitors, a hand held electronic device housing such as a housing for smart phones, tablets, music devices electrical connectors, and components of lighting fixtures, ornaments, home appliances, and the like. In a further aspect, the article is a computer, television, or business machine back light diffusion film. In a still further aspect, the article is a computer back light diffusion film. In a yet further aspect, the article is a television back light diffusion film. In an even further aspect, the article is a LCD panel back light diffusion film.

In a further aspect, the present disclosure pertains to electrical or electronic devices comprising the disclosed blended polycarbonate compositions. In a further aspect, the electrical or electronic device comprising the disclosed blended polycarbonate compositions is a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

In various aspects, the polymer composition can be used in the field of electronics. In a further aspect, non-limiting examples of fields which can use the disclosed blended thermoplastic polymer compositions include electrical, electro-mechanical, radio frequency (RF) technology, telecommunication, automotive, aviation, medical, sensor, military, and security. In a still further aspect, the use of the disclosed blended thermoplastic polymer compositions can also be present in overlapping fields, for example in mechatronic systems that integrate mechanical and electrical properties which may, for example, be used in automotive or medical engineering.

In a further aspect, the article is an electronic device, automotive device, telecommunication device, medical device, security device, or mechatronic device. In a still further aspect, the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device, and RFID device. In yet a further aspect, the article is selected from a computer device, sensor device, security device, RF antenna device, LED device and RFID device. In an even further aspect, the article is selected from a computer device, RF antenna device, LED device and RFID device. In a still further aspect, the article is selected from a RF antenna device, LED device and RFID device. In yet a further aspect, the article is selected from a RF antenna device and RFID device. In an even further aspect, the article is a LED device. In a still further aspect, the LED device is selected from a LED lighting cover, LED tube, a LED socket, and a LED heat sink. In a yet further aspect, the LED device is a LED lighting cover.

In various aspects, molded articles according to the present disclosure can be used to produce a device in one or more of the foregoing fields. In a still further aspect, non-limiting examples of such devices in these fields which can use the disclosed blended thermoplastic polymer compositions according to the present disclosure include computer devices, household appliances, decoration devices, electromagnetic interference devices, printed circuits, Wi-Fi devices, Bluetooth devices, GPS devices, cellular antenna devices, smart phone devices, automotive devices, military devices, aerospace devices, medical devices, such as hearing aids, sensor devices, security devices, shielding devices, RF antenna devices, or RFID devices.

In a further aspect, the molded articles can be used to manufacture devices in the automotive field. In a still further aspect, non-limiting examples of such devices in the automotive field which can use the disclosed blended thermoplastic compositions in the vehicle's interior include adaptive cruise control, headlight sensors, windshield wiper sensors, and door/window switches. In a further aspect, non-limiting examples of devices in the automotive field which can the disclosed blended thermoplastic compositions in the vehicle's exterior include pressure and flow sensors for engine management, air conditioning, crash detection, and exterior lighting fixtures.

In a further aspect, the disclosed compositions can be used to provide any desired shaped, formed, or molded articles. For example, the disclosed compositions can be molded into useful shaped articles by a variety of means such as injection molding, extrusion, rotational molding, blow molding and thermoforming. As noted above, the disclosed compositions are particularly well suited for use in the manufacture of electronic components and devices. As such, according to some aspects, the disclosed compositions can be used to form articles such as printed circuit board carriers, burn in test sockets, flex brackets for hard disk drives, and the like.

In various aspects, the present disclosure pertains to and includes at least the following aspects.

Aspect 1: A blended thermoplastic composition comprising: a) from about 50 wt % to about 95 wt % of a polycarbonate polymer component; b) from about 5 wt % to about 50 wt % of a reinforcing filler; and c) from about 3 wt % to about 7 wt % of a flame retardant; wherein the combined weight percent value of all components does not exceed about 100 wt %; and wherein all weight percent values are based on the total weight of the composition.

Aspect 2: The composition of aspect 1, wherein the polycarbonate polymer component comprises a linear polycarbonate.

Aspect 3: The composition of any one of aspects 1-2, wherein the polycarbonate polymer component comprises a bisphenol A polycarbonate polymer.

Aspect 4: The composition of any one of aspects 1-3, wherein the polycarbonate polymer component comprises a polycarbonate-polysiloxane copolymer.

Aspect 5: The composition of any one of aspects 1-4, wherein the polycarbonate polymer component comprises a linear polycarbonate, a polycarbonate-polysiloxane copolymer, or a combination thereof.

Aspect 6: The composition of any one of aspects 1-5, wherein the reinforcing fiber comprises a glass fiber.

Aspect 7: The composition of any one of aspects 1-6, wherein the glass fiber has a refractive index “n” that is at least substantially similar to the refractive index of the polycarbonate polysiloxane copolymer.

Aspect 8: The composition of any one of aspects 1-7, wherein the flame retardant comprises a phosphorous containing flame retardant.

Aspect 9: The composition of any one of aspects 1-8, wherein the phosphorous containing flame retardant comprises an organophosphorous compound.

Aspect 10: The composition of any one of aspects 1-9, wherein the organophosphorous compound comprises a bisphenol A diphosphate polymer.

Aspect 11: The composition of any one of aspects 1-10, wherein the organophosphorous compound comprises a phenoxyphosphazene.

Aspect 12: The composition of any one of aspects 1-11, further comprising from about 0.5 wt % to about 5 wt % of a flame retardant synergist.

Aspect 13: The composition of any one of aspects 1-12, wherein the flame retardant synergist comprises a siloxane oil.

Aspect 14: The composition of any one of aspects 1-13, wherein the siloxane oil comprises a polymethylphenyl siloxane.

Aspect 15: The composition of any one of aspects 1-13, wherein the siloxane oil comprises a dimethyl diphenyl methyl hydrogen silicone oil.

Aspect 16: The composition of any one of aspects 1-15, having a percent transmission of at least 80% measured according to ASTM D1003 at a thickness of 2 mm.

Aspect 17: The composition of any one of aspects 1-16, having a percent transmission of at least 83% measured according to ASTM D1003 at a thickness of 2 mm.

Aspect 18: The composition of any one of aspects 1-17, having a percent haze of less than or equal to 30% measured according to ASTM D1003 at a thickness of 2 mm.

Aspect 19: The composition of any one of aspects 1-18, having a flame retardancy rating V0 at a thickness of 1.5 mm.

Aspect 20: The composition of any one of aspects 1-19, having a flame retardancy rating V0 at a thickness of 1.2 mm.

Aspect 21: A molded article formed from the composition of any of aspects 1 through 20.

Aspect 22: A method of making a blended thermoplastic composition comprising: a) combining: i) from about 50 wt % to about 95 wt % of a polycarbonate polymer component; ii) from about 5 wt % to about 50 wt % of a reinforcing filler; and iii) from about 3 wt % to about 7 wt % of a flame retardant; wherein the combined weight percent value of all components does not exceed about 100 wt %; and wherein all weight percent values are based on the total weight of the composition.

Aspect 23: The method of aspect 22, further comprising step b) extruding the blended polymer composition.

Aspect 24: The method of any one of aspects 22-23, wherein the polycarbonate polymer component comprises a linear polycarbonate.

Aspect 25: The method of any one of aspects 22-24, wherein the polycarbonate polymer component comprises a bisphenol A polycarbonate polymer.

Aspect 26: The method of any one of aspects 22-25, wherein the polycarbonate polymer component comprises a polycarbonate-polysiloxane copolymer.

Aspect 27: The method of any one of aspects 22-26, wherein the polycarbonate polymer component comprises a linear polycarbonate, a polycarbonate-polysiloxane copolymer, or a combination thereof.

Aspect 28: The method of any one of aspects 22-27, wherein the reinforcing fiber comprises a glass fiber.

Aspect 29: The method of any one of aspects 22-28, wherein the glass fiber has a refractive index “n” that is at least substantially similar to the refractive index of the polycarbonate polysiloxane copolymer of the polycarbonate polysiloxane copolymer.

Aspect 30: The method of any one of aspects 22-29, wherein the flame retardant comprises a phosphorous containing flame retardant.

Aspect 31: The method of any one of aspects 22-30, wherein the phosphorous containing flame retardant comprises an organophosphorous compound.

Aspect 32: The method of any one of aspects 22-31, wherein the organophosphorous compound comprises a bisphenol A diphosphate polymer.

Aspect 33: The method of any one of aspects 22-32, wherein the organophosphorous compound comprises a phenoxyphosphazene.

Aspect 34: The method of any one of aspects 22-33, further comprising from about 0.5 wt % to about 5 wt % of a flame retardant synergist.

Aspect 35: The method of any one of aspects 22-34, wherein the flame retardant synergist comprises siloxane oil.

Aspect 36: The method of any one of aspects 22-35, wherein the siloxane oil comprises a polymethylphenyl siloxane.

Aspect 37: The method of any one of aspects 22-36, wherein the siloxane oil comprises a dimethyl diphenyl methyl hydrogen silicone oil.

Aspect 38: The method of any one of aspects 22-37, having a percent transmission of at least 80% measured according to ASTM D1003 at a thickness of 2 mm.

Aspect 39: The method of any one of aspects 22-38, having a percent transmission of at least 83% measured according to ASTM D1003 at a thickness of 2 mm.

Aspect 40: The method of any one of aspects 22-39, having a percent haze of less than or equal to 30% measured according to ASTM D1003 at a thickness of 2 mm.

Aspect 41: The method of any one of aspects 22-40, having a flame retardancy rating V0 at a thickness of 1.5 mm.

Aspect 42: The method of any one of aspects 21-41, having a flame retardancy rating V0 at a thickness of 1.2 mm.

Without further elaboration, it is believed that one skilled in the art can, using the description herein, utilize the present disclosure. The following examples are included to provide addition guidance to those skilled in the art of practicing the claimed disclosure. The examples provided are merely representative of the work and contribute to the teaching of the present disclosure. Accordingly, these examples are not intended to limit the disclosure in any manner.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior disclosure. Further, the dates of publication provided herein can be different from the actual publication dates, which can require independent confirmation.

### EXAMPLES

The following examples are put forth so as to provide those of ordinary skill in the art with a complete disclosure and description of how the methods, devices, and systems disclosed and claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in degrees Celsius (° C.) or is at ambient temperature, and pressure is at or near atmospheric.

The materials shown in Table 1 were used to prepare the compositions described in and evaluated herein.

TABLE 1

| Component | Chemical description | Source |
|---|---|---|
| PC-PS1 | Transparent BPA polycarbonate-polydimethylsiloxane | SABIC Innovative |
| | block copolymer comprising about 6 wt % of siloxane | Plastics, Inc. (“SABIC |
| | (PDMS residues) and 80 wt % by of BPA; para-cumyl | I.P.” |
| | phenol (“PCP”) end-capped; with a | |
| | polydiorganosiloxane chain length of about 40-60 and | |
| | having a Mw of about 23,000 Daltons. | |
| GF1 | E-glass chopped strand with a cross-sectional diameter | Nippon Electric Glass |
| | of about 13 μm; it is available under the trade name T- | Co., Ltd. |
| | 120. | |
| GF2 | High refractive index glass fiber with fiber length of | Chongqing Polycomp |
| | about 4 mm and a cross-sectional diameter of about 13 μm; | International Corp. |
| | available under the trade name ECR-307. | |
| FRS1 | Polymethylphenyl siloxane solid resin with a softening | Shin-Etsu Silicone |
| | point of about 95° C.; commercially available under | International Trading |
| | the trade name KR-480. | Co., Ltd. |
| FRS2 | Dimethyl diphenyl methyl hydrogen silicone oil; | Shin-Etsu Silicone |
| | commercially available under the trade name KR- | International Trading |
| | 2710. | Co., Ltd. |
| FRS3 | Polymethylphenyl siloxane that is a liquid at room | Toshiba Silicone Co., |
| | temperature with a viscosity of about 22 centistokes at | Ltd. |
| | about 25° C.; commerically available under the trade | |
| | name TSF-437 | |
| FR1 | Aromatic cyclic phosphazene-containing flame | Fushimi |
| | retardant with chemical formula (C₁₂H₁₀NPO₂)ₙ, | Pharmaceutical Co., |
| | wherein n is from about 3 to about 6; commercially | Ltd. |
| | available under the trade name Rabitle FP-110. | |
| FR2 | Bisphenol A bis(diphenyl phosphate), CAS Reg. No. | Daihachi Chemical |
| | 181028-79-5; commercially available under the trade | Industry Co., Ltd. |
| | name CR741. | |
| FR3 | Potassium perfluorobutane sulfonate, CAS No 29420- | 3M Corporation |
| | 49-3; commercially available under the trade name | |
| | FR-2025. | |

For the non-limiting Examples described herein, molded articles were prepared for analysis using representative compounding and molding profiles described in Tables 2 and 3 below, respectively. All samples were prepared by a melt extrusion using a 37 mm Toshiba SE Twin Screw Extruder with co-rotating twin screw (37 mm) with a barrel size of 1500 mm, and a screw speed kept at about 340 rpm with the torque value maintained at about 70% and operated under standard processing conditions well known to one skilled in the art. The flame retardant was pre-blended with all other resin's components and fed into the extruder at a main throat. The inorganic filler such as a glass fiber was fed into the extruder at a downstream.

Pellets of polymer blend compositions were formed via extrusion and were dried at about 110° C. for at least four hours prior to molding the pellets into test samples. The injection molding conditions were carried out at a nozzle temperature of 295° C. and a mold temperature of 100° C.

TABLE 2

| Parameters | Units | Settings |
|---|---|---|
| Barrel Size | mm | 1500 |
| Screw Design | | L-3-1B |
| Die | mm | 4 |
| Feed (Zone 0) Temperature | ° C. | |
| Zone 1 Temperature | ° C. | 100 |
| Zone 2 Temperature | ° C. | 180 |
| Zone 3 Temperature | ° C. | 250 |
| Zone 4 Temperature | ° C. | 260 |
| Zone 5 Temperature | ° C. | 270 |
| Zone 6 Temperature | ° C. | 270 |
| Zone 7 Temperature | ° C. | 270 |
| Zone 8 Temperature | ° C. | 270 |
| Zone 9 Temperature | ° C. | 270 |
| Zone 10 Temperature | ° C. | 270 |
| Zone 11 Temperature | ° C. | 270 |
| Zone 12 Temperature | ° C. | |
| Die Temperature | ° C. | 270 |
| Screw Speed | rpm | 340 |
| Throughput | kg/hr | 60 |

TABLE 3

| Parameters | Unit | Values |
|---|---|---|
| Cnd: Pre-drying time | Hour | 4 |
| Cnd: Pre-drying temp | ° C. | 110 |
| Hopper Temp | ° C. | |
| Zone 1 Temp | ° C. | 270 |
| Zone 2 Temp | ° C. | 290 |
| Zone 3 Temp | ° C. | 300 |
| Zone 4 Temp | ° C. | |
| Nozzle Temp | ° C. | 295 |
| Mold Temp | ° C. | 100 |
| Screw speed | rpm | |
| Back Pressure | kgf/cm² | |
| Injection speed | mm/s | 50-100 |
| Holding pressure | kgf/cm² | 600 |
| Max. Injection pressure | kgf/cm² | 800 |

The testing specimens were evaluated for their optical and physical properties using the test methods described herein below.

The heat deflection temperature (“HDT”) is a relative measure of a material's ability to perform for a short time at elevated temperatures while supporting a load. The test measures the effect of temperature on stiffness: a standard test specimen is given a defined surface stress and the temperature is raised at a uniform rate. HDT test was determined per the ASTM D648 standard using a flat, 3.2 mm thick bar subjected to 1.82 MPa. The HDT is reported in units of ° C.

The notched Izod impact (“NII”) test was carried out on 3.2 mm bars according to ASTM D 256 at 23° C.; the data shown are the average obtained from testing five bars.

NII ductility is reported as the percentage of five samples which, upon failure in the notched Izod impact test, exhibited a ductile failure rather than rigid failure, the latter being characterized by cracking and the formation of shards.

The melt flow rate (“MVR”) was measured at a 300° C. under a 1.2 kg load in accordance with ASTM D1238. The MVR is reported in units of cm³/10 min.

Percent of transmission and haze were measured in accordance with ASTM D1003 on a molded sample with a thickness of 2 mm.

Flammability tests were performed following the procedure of Underwriter's Laboratory Bulletin 94 entitled “Tests for Flammability of Plastic Materials, UL94”, which is incorporated herein by reference. According to this procedure, the materials were classified as either UL94 V0, UL94 V1, or UL94 V2 on the basis of the test results obtained for five samples. The procedure and criteria for each of these flammability classifications according to UL94 are, briefly, as follows. Multiple specimens (either 5 or 10) are tested per thickness. Some specimens are tested after conditioning for 48 hours at 23° C., 50% relative humidity. The other specimens are tested after conditioning for 168 hours at 70° C. The bar is mounted with the long axis vertical for flammability testing. The specimen is supported such that its lower end is 9.5 mm above the Bunsen burner tube. A blue 19 mm high flame is applied to the center of the lower edge of the specimen for 10 seconds. The time until the flaming of the bar ceases is recorded (T1). If burning ceases, the flame is re-applied for an additional 10 seconds. Again, the time until the flaming of the bar ceases is recorded (T2). If the specimen drips particles, these shall be allowed to fall onto a layer of untreated surgical cotton placed 305 mm below the specimen.

V0: In a sample placed so that its long axis is 180 degrees to the flame, the maximum period of flaming and/or smoldering after removing the igniting flame does not exceed 10 seconds and none of the vertically placed samples produces drips of burning particles that ignite absorbent cotton, and no specimen burns up to the holding clamp after flame or after glow.

V1: In a sample places so that its long axis is 180 degree to the flame, the average period of flaming and/or smoldering after removing the igniting flame does not exceed 30 seconds and none of the vertically placed samples produces drips of burning particles that ignite absorbent cotton. Five bar flame out time (FOT) is the sum of the flame out time for five bars, each lit twice for a maximum flame out time of 250 seconds.

The data were also analyzed by calculating the average flame out time, standard deviation of the flame out time and the total number of drips, and by using statistical methods to convert that data to a prediction of the probability of first time pass, or “p(FTP)”, that a particular sample formulation would achieve a “pass” rating in the conventional UL94 V0 or V1 testing of 5 bars. The probability of a first time pass on a first submission (pFTP) may be determined according to the formula:

p(FTP)−(P_{t1>mbt,n=0}XP_{t2>mbt,n=0}XP_{total<=mtbt}XP_{drip,n=0})

where P_{t1>mbt, n=0} is the probability that no first burn time exceeds a maximum burn time value, P_{t2>mbt P, n=0} is the probability that no second burn time exceeds a maximum burn time value, P_{total<=mtbt} is the probability that the sum of the burn times is less than or equal to a maximum total burn time value, and P_{drip, n=0} is the probability that no specimen exhibits dripping during the flame test. First and second burn time refer to burn times after a first and second application of the flame, respectively.

The probability that no first burn time exceeds a maximum burn time value, P_{t1>mbt, n=0}, may be determined the formula:

P_{t1>mbt,n=0}=(1−P_{t1>mbt})⁵

where P_{t1>mbt} is the area under the log normal distribution curve for t1>mbt, and where the exponent “5” relates to the number of bars tested. The probability that no second burn time exceeds a maximum burn time value may be determined from the formula:

P_{t2>mbt,n=0}=(1−P_{t2>mbt})

where P_{t2>mbt} is the area under the normal distribution curve for t2>mbt. As above, the mean and standard deviation of the burn time data set are used to calculate the normal distribution curve. For the UL-94 V0 rating, the maximum burn time is 10 seconds. For a V1 or V2 rating the maximum burn time is 30 seconds. The probability P_{drip, n=0} that no specimen exhibits dripping during the flame test is an attribute function, estimated by:

P_{drip,n=0}=(1−P_{drip})⁵

where P_{drip}=(the number of bars that drip/the number of bars tested).

The probability P_{total<=mtbt} that the sum of the burn times is less than or equal to a maximum total burn time value may be determined from a normal distribution curve of simulated 5-bar total burn times. The distribution may be generated from a Monte Carlo simulation of 1000 sets of five bars using the distribution for the burn time data determined above. Techniques for Monte Carlo simulation are well known in the art. A normal distribution curve for 5-bar total burn times may be generated using the mean and standard deviation of the simulated 1000 sets. Therefore, P_{total<=mtbt} may be determined from the area under a log normal distribution curve of a set of 1000 Monte Carlo simulated 5-bar total burn time for total≦maximum total burn time. For the UL-94 V0 rating, the maximum total burn time is 50 seconds. For a VI or V2 rating, the maximum total burn time is 250 seconds.

For the non-limiting Examples described herein below, sample compositions were prepared using the materials described in Table 1, wherein all amounts are given in wt %. Data for performance of the formulations in various tests are shown in Table 4. The mechanical and optical performance and flammability ratings of the compositions having various amounts of phosphorous based flame retardant are described herein and in Table 5. The composites described herein were prepared accordingly to the compounding and molding profiles described above. The exemplary formulation compositions (labeled as “Ex. 1,” “Ex. 2,” and the like) and various comparator samples (labeled as “Com. 1,” “Com. 2,” and the like) are described in Table 4.

TABLE 4

| Component | Ex. 1 | Ex. 2 | Ex. 3 | Com. 1 | Com. 2 |
|---|---|---|---|---|---|
| PC-PS1 | 74.5 | 74.5 | 72.5 | 79.4 | 79.4 |
| FR1 | 5.0 | — | — | — | — |
| FR2 | — | 5.0 | 7.0 | — | — |
| FR3 | — | — | — | 0.08 | 0.08 |
| GF1 | — | — | — | — | 20 |
| GF2 | 20 | 20 | 20 | 20 | — |
| Formulation Total | 99.5 | 99.5 | 99.5 | 99.5 | 99.5 |

It was observed that addition of phosphorous based flame retardants such as a BDADP (Ex. 2 and Ex. 3) and phenoxyphosphazene (Ex. 1) demonstrated a good flame retardancy performance (i.e. V0 at 1.5 mm) when compared to comparative samples Com. 1 and Com. 2 that had a potassium perfluorobutane sulfonate as the flame retardant additive (see Table 5. The data show that the composites that had potassium perfluorobutane sulfonate as a flame retardant passed V0 at 2.0 mm flammability rating, but failed a flammability rating of V0 at 1.5 mm. Additionally, the data show that addition of a high refractive index glass fiber to the polymer composition (Ex. 1, Ex. 2, and Ex. 3) resulted in significant improvement in the composition's optical properties. All three exemplary compositions (Ex. 1, Ex. 2, and Ex. 3) exhibited a high light transmittance (T>80%) and lower haze (haze˜30%) compared to the comparative sample (Com. 1) having a bonding fiberglass as a filler. Furthermore, it was observed that addition of a high refractive index glass fiber to the composition having a potassium perfluorobutane sulfonate as a flame retardant additive (Com. 2) only slightly improved its optical properties. Without wishing to be bound to any theory, these results can be attributed to the synergetic effect of phosphorus based flame retardants and a high refractive index glass fiber on optical properties of the compositions.

TABLE 5

| Test Description | Unit | Ex. 1 | Ex. 2 | Ex. 3 | Com. 1 | Com. 2 |
|---|---|---|---|---|---|---|
| MVR-Avg | cm³/10 min | 10.2 | 11.0 | 13.5 | 9.5 | 7.4 |
| Impact Strength - Avg | J/m | 152.0 | 116.0 | 104.0 | 154.0 | 197.0 |
| (notched) | | | | | | |
| Deflection temp - Avg | ° C. | 121.0 | 112.0 | 106.0 | 133.0 | 133.0 |
| Transmittance | % | 81.7 | 84.3 | 84.5 | 77.3 | 75.5 |
| Haze | % | 31.9 | 25.8 | 30.3 | 38.8 | 56.9 |
| V0 at 2.0 mm* | | | | | | |
| 23° C., 48 hr | FOT | | | | 68.8 | 68.7 |
| | pFTP | | | | 0.934 | 0.958 |
| 70° C., 168 hr | FOT | | | | 73.6 | 91.1 |
| | pFTP | | | | 0.849 | 0.314 |
| V0 at 1.5 mm, 23° C.* | | | | | | |
| 23° C., 48 hr | FOT | 66.8 | 72.8 | 53.2 | | |
| | pFTP | 0.979 | 0.847 | 0.966 | | |
| 70° C., 168 hr | FOT | 59.0 | 63.2 | 58.7 | FAIL | FAIL |
| | pFTP | 0.998 | 0.984 | 0.999 | | |

*V0 data are shown the average for the results obtained with 10 bars.

To further improve flame retardancy performance, exemplary siloxanes was added to the composition as a FR synergist. The exemplary compositions (Ex. 4, Ex. 5, Ex. 6, and Ex. 7) and comparator samples (Com. 3, Com. 4, Com. 5, and Com. 6) are show in Table 6.

TABLE 6

| Component | Ex. 4 | Ex. 5 | Ex. 6 | Ex. 7 | Ex. 8 |
|---|---|---|---|---|---|
| PC-PS1 | 74.5 | 74.0 | 73.5 | 74.0 | 73.5 |
| FR2 | 5.0 | 5.0 | 5.0 | 5.0 | 5.0 |
| FR3 | — | — | — | — | — |
| FRS2 | — | — | — | 0.5 | 1.0 |
| FRS3 | — | 0.5 | 1.0 | — | — |
| GFS | 20.0 | 20.0 | 20.0 | 20.0 | 20.0 |
| Formulation Total | 99.5 | 99.0 | 99.5 | 99.0 | 99.5 |

| Component | Com. 3 | Com. 4 | Com. 5 | Com. 6 |
|---|---|---|---|---|
| PC-PS1 | 79.4 | 78.4 | 78.4 | 73.5 |
| FR2 | — | — | — | — |
| FR3 | 0.08 | 0.08 | 0.08 | 5.00 |
| FRS2 | — | — | 1.0 | — |
| FRS3 | — | 1.0 | — | 1.0 |
| GF2 | 20.0 | 20.0 | 20.0 | 20.0 |
| Formulation Total | 99.5 | 99.5 | 99.5 | 99.5 |

The data regarding the performance of the compositions comprising at least one FR synergist are shown Table 7. The data show that addition of 0.5-1.0 wt % of a polymethylphenyl siloxane (Ex. 5 and Ex. 6) or 0.5-1.0 wt % of an different siloxane (Ex. 7 and Ex. 8) to the compositions comprising a phosphorous based FR further improved the flame retardancy of these compositions while maintaining good optical properties (T>80%, haze˜30%). In contrast, the addition of a FR synergist to the compositions comprising a potassium perfluoroburate sulfonate flame retardant (Com. 4, Com. 5, and Com. 6) did not provide any improvement in the composition's flame retardancy, even in the presence of a high level of the potassium perfluoroburate sulfonate flame retardant (see results for Com. 6).

TABLE 7

| Test Description | Unit | Ex. 2 | Ex. 5 | Ex. 6 | Ex. 7 | Ex. 8 |
|---|---|---|---|---|---|---|
| Ash | % | 22.1 | 22.3 | 22.2 | 22.8 | 22.7 |
| MVR-Avg | cm³/10 min | 11 | 10.3 | 11.6 | 10.7 | 11.3 |
| Ductility | % | 0 | 0 | 0 | 0 | 0 |
| Impact Strength - Avg | J/m | 116 | 104.0 | 78.8 | 95.6 | 83.2 |
| (notched) | | | | | | |
| Deflection temp - Avg | ° C. | 112 | 112.0 | 111.0 | 112.0 | 111.0 |
| Transmittance | % | 84.3 | 84.4 | 84.7 | 84.6 | 84.9 |
| Haze | % | 25.8 | 28.2 | 24.6 | 29.9 | 27.6 |
| V0* | | | | | | |
| 2.0 mm, 23° C., 48 hr | pFTP | n.d. | n.d. | n.d. | n.d. | n.d. |
| 1.5 mm, 23° C., 48 hr | pFTP | 0.84 | 0.83 | 0.98 | 0.99 | 1.0 |
| 1.2 mm, 23° C., 48 hr | pFTP | FAIL | FAIL | 0.99 | 0.57 | 0.99 |

| Test Description | Unit | Com. 3 | Com. 4 | Com. 5 | Com. 6 |
|---|---|---|---|---|---|
| Ash | % | 22.1 | 21.9 | 22.3 | 22.5 |
| MVR-Avg (275° C./5 kg) | cm³/10 min | 9.5 | 9.6 | 9.7 | 97.7 |
| Ductility | % | 0 | 0 | 0 | 0 |
| Impact Strength - Avg | J/m | 154.0 | 159.0 | 161.0 | 78.3 |
| (notched) | | | | | |
| Deflection temp - Avg | ° C. | 133.0 | 131.0 | 132.0 | 125.0 |
| Transmittance | % | 77.3 | 79.7 | 73.8 | 8.7 |
| Haze | % | 38.8 | 31.3 | 31.1 | 96.5 |
| V0* | | | | | |
| 2.0 mm, 23° C., 48 hr | pFTP | 0.934 | 0.87 | 0.87 | FAIL |
| 1.5 mm, 23° C., 48 hr | pFTP | FAIL | FAIL | FAIL | FAIL |
| 1.2 mm, 23° C., 48 hr | pFTP | | | | |

*V0 data are shown as average results for 10 bars;
“n.d.” indicates that V0 was determined at the indicated test condition.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A blended thermoplastic composition comprising:
a) from about 47 wt % to about 91.5 wt % of a polycarbonate polymer component;
b) from about 5 wt % to about 50 wt % of a reinforcing filler; and
c) from about 3 wt % to about 7 wt % of a flame retardant;
wherein the combined weight percent value of all components does not exceed about 100 wt %; and
wherein all weight percent values are based on the total weight of the composition.

2. The blended thermoplastic composition of claim 1, wherein the polycarbonate polymer component comprises a linear polycarbonate, a polycarbonate-polysiloxane copolymer, or a combination thereof.

3. The blended thermoplastic composition of claim 1, wherein the polycarbonate polymer component comprises a bisphenol A polycarbonate polymer.

4. The blended thermoplastic composition of claim 1, wherein the reinforcing fiber comprises a glass fiber having an refractive index “n” that is at least substantially similar to the refractive index of the polycarbonate polysiloxane copolymer.

5. The blended thermoplastic composition of claim 1, wherein the flame retardant comprises a phosphorous containing flame retardant.

6. The blended thermoplastic composition of claim 5, wherein the phosphorous containing flame retardant comprises an organophosphorous compound.

7. The blended thermoplastic composition of claim 6, wherein the organophosphorous compound comprises a bisphenol A diphosphate polymer or a phenoxyphosphazene, or a combination thereof.

8. The blended thermoplastic composition of claim 1, further comprising from about 0.5 wt % to about 5 wt % of a flame retardant synergist.

9. The blended thermoplastic composition of claim 8, wherein the flame retardant synergist comprises a siloxane oil.

10. The blended thermoplastic composition of claim 9, wherein the siloxane oil comprises a polymethylphenyl siloxane or a dimethyl diphenyl methyl hydrogen silicone oil, or a combination thereof.

11. The blended thermoplastic composition of claim 1, wherein the blended thermoplastic composition has a percent transmission of at least about 80% measured according to ASTM D1003 at a thickness of about 2 mm.

12. The blended thermoplastic composition of claim 1, wherein the blended thermoplastic composition has a percent transmission of at least about 83% measured according to ASTM D1003 at a thickness of about 2 mm.

13. The blended thermoplastic composition of claim 1, wherein the blended thermoplastic composition has a percent haze of less than or equal to about 30% measured according to ASTM D1003 at a thickness of about 2 mm.

14. The blended thermoplastic composition of claim 1, wherein the blended thermoplastic composition has a flame retardancy rating V0 at a thickness of about 1.5 mm.

15. The blended thermoplastic composition of claim 1, wherein the blended thermoplastic composition has a flame retardancy rating V0 at a thickness of about 1.2 mm.

16. A molded article formed from the composition of claim 1.

17. A method of making a blended thermoplastic composition comprising, combining:
i) from about 47 wt % to about 91.5 wt % of a polycarbonate polymer component;
ii) from about 5 wt % to about 50 wt % of a reinforcing filler; and
iii) from about 3 wt % to about 7 wt % of a flame retardant;
wherein the combined weight percent value of all components does not exceed about 100 wt %; and
wherein all weight percent values are based on the total weight of the composition.

18. The method of claim 17, further comprising extruding the blended thermoplastic composition.

19. The method of claim 17, wherein the polycarbonate polymer component comprises a linear polycarbonate, a polycarbonate-polysiloxane copolymer, or a combination thereof.

20. The method of claim 17, wherein the reinforcing fiber comprises a glass fiber having a refractive index “n” that is at least substantially similar to the refractive index of the polycarbonate polysiloxane copolymer of the polycarbonate polysiloxane copolymer.

21. The method of claim 17, wherein the flame retardant comprises a phosphorous containing flame retardant.

22. The method of claim 21, wherein the phosphorous containing flame retardant comprises an organophosphorous compound.

23. The method of claim 22, wherein the organophosphorous compound comprises a bisphenol A diphosphate polymer or a phenoxyphosphazene, or a combination thereof.

24. The method of claim 17, further comprising from about 0.5 wt % to about 5 wt % of a flame retardant synergist.

25. The method of claim 24, wherein the flame retardant synergist comprises a siloxane oil.

26. The method of claim 17, wherein the blended thermoplastic composition has a percent transmission of at least about 80% measured according to ASTM D1003 at a thickness of about 2 mm.

27. The method of claim 17, wherein the blended thermoplastic composition has a percent haze of less than or equal to about 30% measured according to ASTM D1003 at a thickness of about 2 mm.

28. The method of claim 17, wherein the blended thermoplastic composition has a flame retardancy rating V0 at a thickness of about 1.5 mm.
